(19) United States
(12) Patent Application Publication
(10) Pub. No.: US 2025/0142389 A1
(43) Pub. Date: May 1, 2025

(54) BUFFER RESTRICTION FOR TIME-DOMAIN CHANNEL STATE INFORMATION REPORTING

(71) Applicant: QUALCOMM Incorporated, San Diego, CA (US)

(72) Inventors: Jing DAI, Beijing (CN); Chenxi HAO, Beijing (CN); Liangming WU, Beijing (CN); Chao WEI, Beijing (CN); Lei XIAO, San Jose, CA (US); Faris RASSAM, El Cajon, CA (US); Min HUANG, Beijing (CN); Wei XI, Beijing (CN); Hao XU, Beijing (CN)

(21) Appl. No.: 18/837,126

(22) PCT Filed: Apr. 24, 2022
(86) PCT No.: PCT/CN2022/088683

§ 371 Date: Aug. 8, 2024

(51) Int. Cl. H04W 24/10; H04W 72/0446

(52) U.S. Cl. CPC H04W 24/10; H04W 72/0446

(57) ABSTRACT

Methods, systems, and devices for wireless communications are described. A user equipment (UE) may receive from a network entity, a control message triggering the UE to provide a time-domain aperiodic channel state information (A-CSI) report for indicating time-domain channel state information (CSI) associated with CSI reference signal (CSI-RS) resources within an observation window, where a beginning of the observation window is based on when the control message is received. The UE may perform performing measurements of channel state information reference signals (CSI-RSs) received via the CSI-RS resources that occur within the observation window. The UE may then transmit, to the network entity based on the control message, the time-domain A-CSI report indicating measured time-domain CSI associated with the observation window, where the measured time-domain CSI is based on the measurements.

### CROSS REFERENCE

The present Application is a 371 national phase filing of International PCT Application No. PCT/CN2022/088683 by DAI et al., entitled “BUFFER RESTRICTION FOR TIME-DOMAIN CHANNEL STATE INFORMATION REPORTING,” filed Apr. 24, 2022, which is assigned to the assignee hereof, and which is expressly incorporated by reference in its entirety herein.

### FIELD OF TECHNOLOGY

The following relates to wireless communications, including buffer restriction for time-domain channel state information (CSI) reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, UEs are configured to measure reference signals (e.g., channel state information (CSI) reference signals (CSI-RSs)) received from the network, and transmit CSI reports to inform the network as to the relative quality and performance of a channel between the UE and the network. In some cases, the network may trigger an aperiodic CSI report for time-domain CSI reporting. In such cases, the UE is expected to generate an aperiodic CSI report indicating time-domain CSI metrics over some time period.

### SUMMARY

The described techniques relate to improved methods, systems, devices, and apparatuses that support buffer restriction for time-domain channel state information (CSI) reporting. Generally, aspects of the present disclosure support techniques which enable user equipments (UEs) to buffer/store defined quantities of CSI measurements for time-domain aperiodic CSI reporting. In particular, aspects of the present disclosure may support CSI reporting configurations which cause UEs to report time-domain CSI within an observation window, where the observation window starts relative to (e.g., based on) when the UE is triggered to provide an time-domain aperiodic CSI report, thereby limiting how many CSI measurements the UE is expected to buffer before the trigger for the CSI report is received. In some implementations, the observation window for time-domain aperiodic CSI reports may be based on a computational consumption at the UE (e.g., how many concurrent, separate CSI measurement processes the UE is capable of performing). In additional or alternative implementations, the observation window may start after the trigger for the aperiodic CSI report is received, or may include some quantity of CSI reference signal (CSI-RS) resources (e.g., one CSI-RS resource) observed prior to receiving the trigger.

A method for wireless communication at a UE is described. The method may include receiving, from a network entity, a control message triggering the UE to provide a time-domain aperiodic CSI report for indicating time-domain CSI associated with CSI-RS resources within an observation window, where a beginning of the observation window is based on when the control message is received, performing measurements of CSI-RSs received via the CSI-RS resources that occur within the observation window, and transmitting, to the network entity and based on the control message, the time-domain aperiodic CSI report indicating measured time-domain CSI associated with the observation window, where the measured time-domain CSI is based on the measurements.

An apparatus for wireless communication at a UE is described. The apparatus may include a processor, memory coupled with the processor, and instructions stored in the memory. The instructions may be executable by the processor to cause the apparatus to receive, from a network entity, a control message triggering the UE to provide a time-domain aperiodic CSI report for indicating time-domain CSI associated with CSI-RS resources within an observation window, where a beginning of the observation window is based on when the control message is received, perform measurements of CSI-RSs received via the CSI-RS resources that occur within the observation window, and transmit, to the network entity and based on the control message, the time-domain aperiodic CSI report indicating measured time-domain CSI associated with the observation window, where the measured time-domain CSI is based on the measurements.

Another apparatus for wireless communication at a UE is described. The apparatus may include means for receiving, from a network entity, a control message triggering the UE to provide a time-domain aperiodic CSI report for indicating time-domain CSI associated with CSI-RS resources within an observation window, where a beginning of the observation window is based on when the control message is received, means for performing measurements of CSI-RSs received via the CSI-RS resources that occur within the observation window, and means for transmitting, to the network entity and based on the control message, the time-domain aperiodic CSI report indicating measured time-domain CSI associated with the observation window, where the measured time-domain CSI is based on the measurements.

A non-transitory computer-readable medium storing code for wireless communication at a UE is described. The code may include instructions executable by a processor to receive, from a network entity, a control message triggering the UE to provide a time-domain aperiodic CSI report for indicating time-domain CSI associated with CSI-RS resources within an observation window, where a beginning of the observation window is based on when the control message is received, perform measurements of CSI-RSs received via the CSI-RS resources that occur within the observation window, and transmit, to the network entity and based on the control message, the time-domain aperiodic CSI report indicating measured time-domain CSI associated with the observation window, where the measured time-domain CSI is based on the measurements.

Some examples of the method, apparatuses, and non-transitory computer-readable medium described herein may further include operations, features, means, or instructions for performing an additional measurement of an additional CSI-RS received within an additional CSI-RS resource that occurs prior to receiving the control message, where the observation window includes the additional CSI-RS resource and transmitting the time-domain aperiodic CSI report including the measured time-domain CSI that may be based on the additional measurement.

Some examples of the method, apparatuses, and non-transitory computer-readable medium described herein may further include operations, features, means, or instructions for receiving control signaling indicating a set of multiple periodic CSI-RS resources including the CSI-RS resources and the additional CSI-RS resource, where receiving the control message, performing the measurements on the CSI-RSs received via the CSI-RS resources, performing the additional measurement, or any combination thereof, may be based on the control signaling.

In some examples of the method, apparatuses, and non-transitory computer-readable medium described herein, the set of multiple periodic CSI-RS resources may be associated with a periodicity and an offset between the additional CSI-RS resource and the control message may be less than the periodicity.

Some examples of the method, apparatuses, and non-transitory computer-readable medium described herein may further include operations, features, means, or instructions for storing or buffering the additional measurement in memory in accordance with a CSI reporting configuration, where the UE stores or buffers in memory a most recent CSI-RS measurement based on the CSI reporting configuration, where the additional measurement may be the most recent CSI-RS measurement that may be stored or buffered in memory.

Some examples of the method, apparatuses, and non-transitory computer-readable medium described herein may further include operations, features, means, or instructions for operating in accordance with an inactive duration of a discontinuous reception configuration during a last CSI-RS resource that may be prior to the control message in a time domain, where the observation window begins after receiving the control message based on operating in accordance with the inactive duration of the discontinuous reception configuration.

In some examples of the method, apparatuses, and non-transitory computer-readable medium described herein, an inactivity timer associated with the discontinuous reception configuration may be greater than or equal to the observation window in a time domain.

In some examples of the method, apparatuses, and non-transitory computer-readable medium described herein, the CSI-RS resources within the observation window include aperiodic CSI-RS resources, semi-persistent CSI-RS resources, or both and the observation window begins after receiving the control message.

Some examples of the method, apparatuses, and non-transitory computer-readable medium described herein may further include operations, features, means, or instructions for receiving, via the control message, an indication of the CSI-RS resources within the observation window and an indication of a downlink spatial filter associated with each of the CSI-RS resources, the CSI-RS resources including one or more aperiodic CSI-RS resources, where performing the measurements on the CSI-RSs may be based on receiving the indication of the downlink spatial filter.

In some examples of the method, apparatuses, and non-transitory computer-readable medium described herein, the CSI-RS resources may be associated with a semi-persistent CSI-RS resource set and the method, apparatuses, and non-transitory computer-readable medium may include further operations, features, means, or instructions for receiving, via the control message, an indication of a time duration associated with the CSI-RS resource set, where the measurements may be performed on the CSI-RSs within the time duration and within the observation window.

Some examples of the method, apparatuses, and non-transitory computer-readable medium described herein may further include operations, features, means, or instructions for receiving control signaling indicating a first set of CSI-RS resources including the CSI-RS resources, the first set of CSI-RS resources including periodic resources, where performing the measurements of the CSI-RSs may be based on receiving the control signaling, receiving, via the control message, an indication of a second set of CSI-RS resources within the observation window, the second set of CSI-RS resources including aperiodic resources, semi-persistent resources, or both, and performing additional measurements of the second set of CSI-RS resources within the observation window based on the control message, where the time-domain CSI may be based on the measurements and the additional measurements.

In some examples of the method, apparatuses, and non-transitory computer-readable medium described herein, the first set of CSI-RS resources and the second set of CSI-RS resources may be associated with a same downlink spatial filter.

In some examples of the method, apparatuses, and non-transitory computer-readable medium described herein, the control message includes a physical downlink control channel message.

A method for wireless communication at a UE is described. The method may include receiving, from a network entity, control signaling indicating a CSI reporting configuration for time-domain CSI reporting, performing a quantity of measurements of a set of multiple CSI-RSs in accordance with the CSI reporting configuration, where the quantity of measurements is based on a computational consumption associated with the UE, and where the quantity of measurements are buffered in memory, receiving, from the network entity, a control message triggering the UE to provide a time-domain aperiodic CSI report for indicating time-domain CSI, and transmitting the time-domain aperiodic CSI report to the network entity based on the control message, the time-domain aperiodic CSI report indicating the quantity of measurements buffered in memory.

An apparatus for wireless communication at a UE is described. The apparatus may include a processor, memory coupled with the processor, and instructions stored in the memory. The instructions may be executable by the processor to cause the apparatus to receive, from a network entity, control signaling indicating a CSI reporting configuration for time-domain CSI reporting, perform a quantity of measurements of a set of multiple CSI-RSs in accordance with the CSI reporting configuration, where the quantity of measurements is based on a computational consumption associated with the UE, and where the quantity of measurements are buffered in memory, receive, from the network entity, a control message triggering the UE to provide a time-domain aperiodic CSI report for indicating time-domain CSI, and transmit the time-domain aperiodic CSI report to the network entity based on the control message, the time-domain aperiodic CSI report indicating the quantity of measurements buffered in memory.

Another apparatus for wireless communication at a UE is described. The apparatus may include means for receiving, from a network entity, control signaling indicating a CSI reporting configuration for time-domain CSI reporting, means for performing a quantity of measurements of a set of multiple CSI-RSs in accordance with the CSI reporting configuration, where the quantity of measurements is based on a computational consumption associated with the UE, and where the quantity of measurements are buffered in memory, means for receiving, from the network entity, a control message triggering the UE to provide a time-domain aperiodic CSI report for indicating time-domain CSI, and means for transmitting the time-domain aperiodic CSI report to the network entity based on the control message, the time-domain aperiodic CSI report indicating the quantity of measurements buffered in memory.

A non-transitory computer-readable medium storing code for wireless communication at a UE is described. The code may include instructions executable by a processor to receive, from a network entity, control signaling indicating a CSI reporting configuration for time-domain CSI reporting, perform a quantity of measurements of a set of multiple CSI-RSs in accordance with the CSI reporting configuration, where the quantity of measurements is based on a computational consumption associated with the UE, and where the quantity of measurements are buffered in memory, receive, from the network entity, a control message triggering the UE to provide a time-domain aperiodic CSI report for indicating time-domain CSI, and transmit the time-domain aperiodic CSI report to the network entity based on the control message, the time-domain aperiodic CSI report indicating the quantity of measurements buffered in memory.

Some examples of the method, apparatuses, and non-transitory computer-readable medium described herein may further include operations, features, means, or instructions for transmitting, to the network entity, capability signaling associated with the computational consumption at the UE, where receiving the control signaling, performing the quantity of measurements, or both, may be based on the capability signaling.

In some examples of the method, apparatuses, and non-transitory computer-readable medium described herein, the computational consumption may be associated with a quantity of occupied central processing units at the UE, a quantity of active CSI-RS ports at the UE, or both.

A method for wireless communication at a network entity is described. The method may include transmitting, to a UE, a control message triggering the UE to provide a time-domain aperiodic CSI report for indicating time-domain CSI associated with CSI-RS resources within an observation window, where a beginning of the observation window is based on when the control message is received, transmitting CSI-RSs via the CSI-RS resources that occur within the observation window, and receiving, from the UE and based on transmitting the CSI-RSs, the time-domain aperiodic CSI report indicating measured time-domain CSI associated with the observation window, where the measured time-domain CSI is based on the CSI-RSs.

An apparatus for wireless communication at a network entity is described. The apparatus may include a processor, memory coupled with the processor, and instructions stored in the memory. The instructions may be executable by the processor to cause the apparatus to transmit, to a UE, a control message triggering the UE to provide a time-domain aperiodic CSI report for indicating time-domain CSI associated with CSI-RS resources within an observation window, where a beginning of the observation window is based on when the control message is received, transmit CSI-RSs via the CSI-RS resources that occur within the observation window, and receive, from the UE and based on transmitting the CSI-RSs, the time-domain aperiodic CSI report indicating measured time-domain CSI associated with the observation window, where the measured time-domain CSI is based on the CSI-RSs.

Another apparatus for wireless communication at a network entity is described. The apparatus may include means for transmitting, to a UE, a control message triggering the UE to provide a time-domain aperiodic CSI report for indicating time-domain CSI associated with CSI-RS resources within an observation window, where a beginning of the observation window is based on when the control message is received, means for transmitting CSI-RSs via the CSI-RS resources that occur within the observation window, and means for receiving, from the UE and based on transmitting the CSI-RSs, the time-domain aperiodic CSI report indicating measured time-domain CSI associated with the observation window, where the measured time-domain CSI is based on the CSI-RSs.

A non-transitory computer-readable medium storing code for wireless communication at a network entity is described. The code may include instructions executable by a processor to transmit, to a UE, a control message triggering the UE to provide a time-domain aperiodic CSI report for indicating time-domain CSI associated with CSI-RS resources within an observation window, where a beginning of the observation window is based on when the control message is received, transmit CSI-RSs via the CSI-RS resources that occur within the observation window, and receive, from the UE and based on transmitting the CSI-RSs, the time-domain aperiodic CSI report indicating measured time-domain CSI associated with the observation window, where the measured time-domain CSI is based on the CSI-RSs.

Some examples of the method, apparatuses, and non-transitory computer-readable medium described herein may further include operations, features, means, or instructions for transmitting an additional CSI-RS via an additional CSI-RS resource that occurs prior to transmitting the control message, where the observation window includes the additional CSI-RS resource and receiving the time-domain aperiodic CSI report including the measured time-domain CSI that may be based on the additional CSI-RS.

Some examples of the method, apparatuses, and non-transitory computer-readable medium described herein may further include operations, features, means, or instructions for transmitting control signaling indicating a set of multiple periodic CSI-RS resources including the CSI-RS resources and the additional CSI-RS resource, where transmitting the control message, transmitting the CSI-RSs via the CSI-RS resources, transmitting the additional CSI-RS, or any combination thereof, may be based on the control signaling.

In some examples of the method, apparatuses, and non-transitory computer-readable medium described herein, the set of multiple periodic CSI-RS resources may be associated with a periodicity and an offset between the additional CSI-RS resource and the control message may be less than the periodicity.

In some examples of the method, apparatuses, and non-transitory computer-readable medium described herein, the observation window begins after receiving the control message based on a discontinuous reception configuration at the UE.

In some examples of the method, apparatuses, and non-transitory computer-readable medium described herein, an inactivity timer associated with the discontinuous reception configuration may be greater than or equal to the observation window in a time domain.

In some examples of the method, apparatuses, and non-transitory computer-readable medium described herein, the CSI-RS resources within the observation window include aperiodic CSI-RS resources, semi-persistent CSI-RS resources, or both and the observation window begins after transmitting the control message.

Some examples of the method, apparatuses, and non-transitory computer-readable medium described herein may further include operations, features, means, or instructions for transmitting, via the control message, an indication of the CSI-RS resources within the observation window and an indication of a downlink spatial filter associated with each of the CSI-RS resources, the CSI-RS resources including one or more aperiodic CSI-RS resources, where transmitting the CSI-RSs may be based on the downlink spatial filter.

In some examples of the method, apparatuses, and non-transitory computer-readable medium described herein, the CSI-RS resources may be associated with a semi-persistent CSI-RS resource set and the method, apparatuses, and non-transitory computer-readable medium may include further operations, features, means, or instructions for transmitting, via the control message, an indication of a time duration associated with the semi-persistent CSI-RS resource set, where the CSI-RSs may be transmitted within the time duration and within the observation window.

Some examples of the method, apparatuses, and non-transitory computer-readable medium described herein may further include operations, features, means, or instructions for transmitting control signaling indicating a first set of CSI-RS resources including the CSI-RS resources, the first set of CSI-RS resources including periodic resources, where transmitting the CSI-RSs may be based on the control signaling and transmitting, via the control message, an indication of a second set of CSI-RS resources within the observation window, the second set of CSI-RS resources including aperiodic resources, semi-persistent resources, or both, where the time-domain CSI included may be based on the first set of CSI-RS resources and the second set of CSI-RS resources.

In some examples of the method, apparatuses, and non-transitory computer-readable medium described herein, the first set of CSI-RS resources and the second set of CSI-RS resources may be associated with a same downlink spatial filter.

In some examples of the method, apparatuses, and non-transitory computer-readable medium described herein, the control message includes a physical downlink control channel message.

A method for wireless communication at a network entity is described. The method may include transmitting, to a UE, control signaling indicating a CSI reporting configuration for time-domain CSI reporting, transmitting a set of multiple CSI-RSs in accordance with the CSI reporting configuration, transmitting a control message triggering the UE to provide a time-domain aperiodic CSI report for indicating time-domain CSI, and receiving the time-domain aperiodic CSI report based on the control message, the time-domain aperiodic CSI report indicating a quantity of measurements performed on the set of multiple CSI-RSs, where the quantity of measurements is based on a computational consumption associated with the UE.

An apparatus for wireless communication at a network entity is described. The apparatus may include a processor, memory coupled with the processor, and instructions stored in the memory. The instructions may be executable by the processor to cause the apparatus to transmit, to a UE, control signaling indicating a CSI reporting configuration for time-domain CSI reporting, transmit a set of multiple CSI-RSs in accordance with the CSI reporting configuration, transmit a control message triggering the UE to provide a time-domain aperiodic CSI report for indicating time-domain CSI, and receive the time-domain aperiodic CSI report based on the control message, the time-domain aperiodic CSI report indicating a quantity of measurements performed on the set of multiple CSI-RSs, where the quantity of measurements is based on a computational consumption associated with the UE.

Another apparatus for wireless communication at a network entity is described. The apparatus may include means for transmitting, to a UE, control signaling indicating a CSI reporting configuration for time-domain CSI reporting, means for transmitting a set of multiple CSI-RSs in accordance with the CSI reporting configuration, means for transmitting a control message triggering the UE to provide a time-domain aperiodic CSI report for indicating time-domain CSI, and means for receiving the time-domain aperiodic CSI report based on the control message, the time-domain aperiodic CSI report indicating a quantity of measurements performed on the set of multiple CSI-RSs, where the quantity of measurements is based on a computational consumption associated with the UE.

A non-transitory computer-readable medium storing code for wireless communication at a network entity is described. The code may include instructions executable by a processor to transmit, to a UE, control signaling indicating a CSI reporting configuration for time-domain CSI reporting, transmit a set of multiple CSI-RSs in accordance with the CSI reporting configuration, transmit a control message triggering the UE to provide a time-domain aperiodic CSI report for indicating time-domain CSI, and receive the time-domain aperiodic CSI report based on the control message, the time-domain aperiodic CSI report indicating a quantity of measurements performed on the set of multiple CSI-RSs, where the quantity of measurements is based on a computational consumption associated with the UE.

Some examples of the method, apparatuses, and non-transitory computer-readable medium described herein may further include operations, features, means, or instructions for receiving, from the UE, capability signaling associated with the computational consumption at the UE, where transmitting the control signaling, transmitting the set of multiple CSI-RSs, or both, may be based on the capability signaling.

In some examples of the method, apparatuses, and non-transitory computer-readable medium described herein, the computational consumption may be associated with a quantity of occupied central processing units at the UE, a quantity of active CSI-RS ports at the UE, or both.

### BRIEF DESCRIPTION OF THE DRAWINGS

FIG. 1 illustrates an example of a wireless communications system that supports buffer restriction for time-domain channel state information (CSI) reporting in accordance with one or more aspects of the present disclosure.

FIG. 2 illustrates an example of a CSI reporting configuration that supports buffer restriction for time-domain CSI reporting in accordance with one or more aspects of the present disclosure.

FIG. 3 illustrates an example of a wireless communications system that supports buffer restriction for time-domain CSI reporting in accordance with one or more aspects of the present disclosure.

FIG. 4 illustrates an example of a resource configuration that supports buffer restriction for time-domain CSI reporting in accordance with one or more aspects of the present disclosure.

FIG. 5 illustrates an example of a process flow that supports buffer restriction for time-domain CSI reporting in accordance with one or more aspects of the present disclosure.

FIG. 6 illustrates an example of a process flow that supports buffer restriction for time-domain CSI reporting in accordance with one or more aspects of the present disclosure.

FIGS. 7 and 8 show block diagrams of devices that support buffer restriction for time-domain CSI reporting in accordance with one or more aspects of the present disclosure.

FIG. 9 shows a block diagram of a communications manager that supports buffer restriction for time-domain CSI reporting in accordance with one or more aspects of the present disclosure.

FIG. 10 shows a diagram of a system including a device that supports buffer restriction for time-domain CSI reporting in accordance with one or more aspects of the present disclosure.

FIGS. 11 and 12 show block diagrams of devices that support buffer restriction for time-domain CSI reporting in accordance with one or more aspects of the present disclosure.

FIG. 13 shows a block diagram of a communications manager that supports buffer restriction for time-domain CSI reporting in accordance with one or more aspects of the present disclosure.

FIG. 14 shows a diagram of a system including a device that supports buffer restriction for time-domain CSI reporting in accordance with one or more aspects of the present disclosure.

FIGS. 15 through 19 show flowcharts illustrating methods that support buffer restriction for time-domain CSI reporting in accordance with one or more aspects of the present disclosure.

### DETAILED DESCRIPTION

In some wireless communications systems, user equipments (UEs) are configured to measure reference signals (e.g., channel state information (CSI) reference signals (CSI-RSs)) received from the network, and transmit CSI reports to inform the network as to the relative quality and performance of a channel between the UE and the network. UEs may be configured with periodic, semi-persistent, and aperiodic CSI-RS resources. In some cases, the network may trigger an aperiodic CSI report for time-domain CSI reporting. In such cases, the UE is expected to generate an aperiodic CSI report indicating time-domain CSI metrics over some time period. As such, the UE may be expected to buffer (e.g., save, store) a window of CSI-RS measurements performed over time in the event the network triggers an time-domain aperiodic CSI report. However, buffering (e.g., storing) large quantities of CSI-RS measurements results in increased processing resources at the UE, larger memory requirements at the UE, and wasted power used to buffer CSI-RS measurements in cases where aperiodic reports are not triggered.

Accordingly, aspects of the present disclosure are directed to techniques which enable UEs to buffer/store defined quantities of CSI-RS measurements for time-domain aperiodic CSI reporting. In other words, aspects of the present disclosure enable UEs to buffer/store some quantity of CSI measurements measured at multiple points in time (e.g., “time-domain CSI”) to enable the UE to report how CSI changes over time. In particular, aspects of the present disclosure may support CSI reporting configurations which cause UEs to report time-domain CSI within an observation window, where the observation window starts relative to (e.g., based on) when the UE is triggered to provide an time-domain aperiodic CSI report, thereby limiting how many CSI measurements the UE is expected to buffer before the trigger for the CSI report is received.

By defining an observation window for time-domain aperiodic CSI reporting, techniques described herein may limit a quantity of CSI measurements and associated information that the UE is expected to buffer or store in memory. As such, techniques described herein may reduce processing resources used to buffer large quantities of CSI measurements and reduce memory requirements at the UE. Moreover, by reducing a burden on processing resources, techniques described herein may reduce a power consumption at the UE, and reduce or prevent wasted processing resources in the event the UE is not triggered to perform an time-domain aperiodic CSI report.

In some implementations, the observation window may start one CSI-RS resource prior to when the trigger for the time-domain aperiodic CSI report is received such that the UE is expected to buffer a maximum of one CSI measurement for time-domain aperiodic CSI reports. In additional or alternative implementations, the observation window may start after the trigger for the aperiodic CSI report is received, such as in the case of aperiodic CSI-RSs, or in cases where the UE was operating in an inactive duration of a discontinuous reception (DRX) cycle during a CSI-RS resource immediately prior to the received trigger.

Aspects described herein define rules or conditions used to determine the start of an observation window for an time-domain aperiodic CSI report based on when the trigger for the time-domain CSI report is received. In particular, techniques described herein may be used to define observation windows for aperiodic CSI reporting to reduce or limit a quantity of CSI measurements the UE is expected to buffer. For example, in cases where the observation window starts one CSI-RS resource prior to the trigger for the time-domain aperiodic CSI report, the UE is expected to buffer a maximum of one CSI measurement, which may reduce complexity, processing resources, and memory requirements at the UE.

In some implementations, the observation window for an time-domain aperiodic CSI report may be defined based on a computational consumption of the UE. In some cases, the computational consumption may include how many concurrent, separate CSI measurement processes the UE is capable of performing. In such cases, the UE may buffer (e.g., store) a defined quantity of CSI measurements prior to receiving a trigger for an time-domain aperiodic CSI report based on how many CSI reports the UE has been concurrently triggered to provide. Limiting buffered CSI measurements based on a computational consumption may limit how many CSI measurements the UE is required to store before the trigger is received.

Aspects of the disclosure are initially described in the context of wireless communications systems. Additional aspects of the present disclosure are described in the context of an example CSI reporting configuration and example process flows. Aspects of the disclosure are further illustrated by and described with reference to apparatus diagrams, system diagrams, and flowcharts that relate to buffer restriction for time-domain CSI reporting.

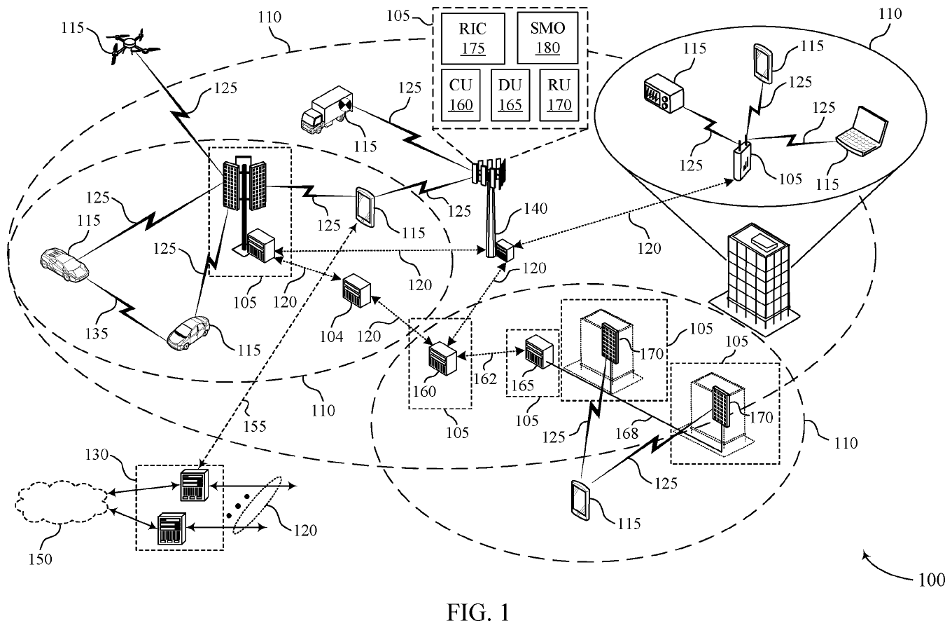

FIG. 1 illustrates an example of a wireless communications system 100 that supports buffer restriction for time-domain CSI reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support buffer restriction for time-domain CSI reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The UEs 115 and network entities 105 of the wireless communications system 100 may be configured to support techniques which enable the UEs 115 to buffer/store defined quantities of CSI measurements for time-domain aperiodic CSI reporting. In particular, aspects of the present disclosure may support CSI reporting configurations which cause UEs 115 to report time-domain CSI within an observation window, where the observation window starts relative to (e.g., based on) when the UE is triggered to provide an time-domain aperiodic CSI report, thereby limiting how many CSI measurements the UE is expected to buffer before the trigger for the CSI report is received. In some implementations, the observation window may start after the trigger for the aperiodic CSI report is received, or may include some quantity of CSI-RS resources (e.g., one CSI-RS resource) observed prior to receiving the trigger. In additional or alternative implementations, the observation window for time-domain aperiodic CSI reports may be based on a computational consumption at the UE 115 (e.g., how many concurrent, separate CSI measurement processes the UE is capable of performing).

For example, in some cases, the observation window for an time-domain aperiodic CSI report may start one CSI-RS resource prior to when the trigger for the time-domain aperiodic CSI report is received such that a UE 115 is expected to buffer a maximum of one CSI measurement for time-domain aperiodic CSI reports. In additional or alternative implementations, the observation window may start after the trigger for the aperiodic CSI report is received. For example, in cases where the trigger schedules aperiodic CSI-RSs, or in cases where the UE 115 was operating in an inactive duration of a DRX cycle during a CSI-RS resource immediately prior to the received trigger, the observation window for the time-domain aperiodic CSI report may start after the trigger is received.

In additional or alternative implementations, the observation window for an time-domain aperiodic CSI report may be defined based on a computational consumption of the UE 115. In some cases, the computational consumption may include how many concurrent, separate CSI measurement processes the UE 115 is capable of performing. In such cases, the UE 115 may buffer (e.g., store) a defined quantity of CSI measurements prior to receiving a trigger for an time-domain aperiodic CSI report based on how many CSI reports the UE 115 has been concurrently triggered to provide. Limiting buffered CSI measurements based on a computational consumption may limit how many CSI measurements the UE is required to store before the trigger is received.

Techniques described herein may be used to define observation windows over which time-domain CSI is to be measured and reported via time-domain aperiodic CSI reports. By defining an observation window for time-domain aperiodic CSI reporting, techniques described herein may limit a quantity of CSI measurements and associated information that UEs 115 are expected to buffer or store in memory. As such, techniques described herein may reduce processing resources used to buffer large quantities of CSI measurements and reduce memory requirements at the respective UEs 115. Moreover, by reducing a burden on processing resources, techniques described herein may reduce a power consumption at the UEs 115, and reduce or prevent wasted processing resources in the event the UEs 115 are not triggered to perform an time-domain aperiodic CSI report.

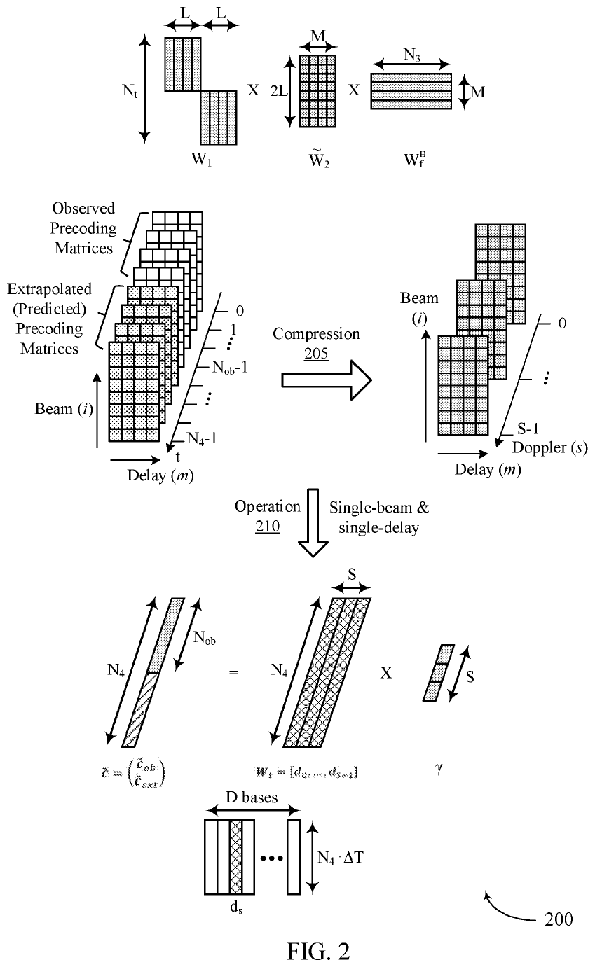

FIG. 2 illustrates an example of a CSI reporting configuration 200 that supports buffer restriction for time-domain CSI reporting in accordance with one or more aspects of the present disclosure. In particular, the CSI reporting configuration 200 illustrates an example of eType-II CSI reporting.

In the context of CSI reporting, and as illustrated in FIG. 2, a precoding matrix (W) for a layer may be defined according to Equation 1 below:

$$W = {W}_{1} \times {\tilde{W}}_{2} \times {W}_{f}^{H} \qquad ( 1 )$$

where W₁ indicates selected spatial-domain bases, W_{f}^{H} indicates selected frequency-domain bases, and \tilde{W}₂ indicates a coefficient matrix (e.g., PMI).

As noted previously herein, channel conditions between a UE 115 and the network may change frequently, particularly in medium and high-velocity scenarios (e.g., cases where the UE 115 is aboard a high-velocity train). As such, to accommodate for channel conditions changing over time, UEs 115 may utilize different precoding matrices over time, where precoding matrices are associated with or indicated via PMIs. For medium and high velocity channels, wireless devices may use a time-domain codebook to represent the fast-varying (over time instance n) precoding matrix, as illustrated in Equation 2 below:

$$W ( n ) = {W}_{1} \times {\tilde{W}}_{2} ( n ) \times {W}_{f}^{H} \qquad ( 2 )$$

Wireless devices (e.g., UEs 115) may perform compression procedures to compress time-domain CSI from the time domain to the Doppler domain (e.g., time-domain compression). Compression of the coefficient matrix \tilde{W}₂(n) into the Doppler domain is illustrated in Equation 3 below:

$${\tilde{W}}_{2} ( n ) = {[ {\tilde{c}}_{i , m} ( n ) ]}_{\begin{matrix}i = 0 , … , 2 L - 1 \\ m = 0 , … , M - 1\end{matrix}} , n = 0 , … , {N}_{4} - 1 \qquad ( 3 )$$

Time-domain compression is further illustrated via the compression 205 illustrated in FIG. 2. As shown in FIG. 2, a UE 115 may convert both observed and predicted/extrapolated precoding matrices from the time domain to the Doppler domain via compression 205. Each precoding matrix may be associated with a beam domain (i) and a delay domain (m). The observed and extrapolated precoding matrices may be calculated for different time instances or time intervals (e.g., time intervals 0, 1, N_{ob}−1, . . . , N₄−1). The observed precoding matrices may be determined/calculated on CSI measurements actually performed by the UE 115 (e.g., for time intervals in the past). Comparatively, the predicted/extrapolated precoding matrices may be predicted/extrapolated into the future based on performed CSI measurements (e.g., for time intervals in the future). In other words, the predicted/extrapolated precoding matrices may include precoding matrices the UE 115 expects to use in the future based on past CSI measurements.

Compression of the coefficient matrix \tilde{W}₂(n) according to Equation 3 above may result in Equation 4 and Equation 5 below:

$${\tilde{c}}_{i , m} ( n ) = {\sum }_{s = 0}^{S - 1} {d}_{s , i , m} ( n ) \cdot {γ}_{s , i , m} , n = 0 , … , {N}_{4} - 1 \qquad ( 4 )$$

$${\tilde{c}}_{i , m} = {[ {W}_{t} ]}_{i , m} \times {γ}_{i , m} = [ {d}_{0 , i , m} , … , {d}_{S - 1 , i , m} ] \times {γ}_{i , m} \qquad ( 5 )$$

For single-beam and single-delay scenarios, beam index i and delay index m may be omitted or dropped, as illustrated in operation 210 illustrated in FIG. 2, which may result in Equation 6 and Equation 7 below:

$$\tilde{c} = ( \frac{{\tilde{c}}_{ob}}{{\tilde{c}}_{ext}} ) = {W}_{t} \times γ = [ {d}_{0} , … , {d}_{S - 1} ] \times γ \qquad ( 6 )$$

$${d}_{s} = {[ 1 , {e}^{j 2 π \frac{s}{D}} , … , {e}^{j 2 π \frac{s ( {N}_{4} - 1 )}{D}} ]}^{T} , s = 0 , 1 , … , D \qquad ( 7 )$$

where dₛ,s=0, 1, . . . , S−1 is the selected time-domain bases to form a time-domain basis matrix Wₜ, \tilde{c}_{ob} is the spatial and frequency-domain bases coefficients for observed CSI-RSS, ćₑₓₜ is the extrapolated spatial and frequency-domain bases coefficients, and γ defines the coefficients jointly with spatial-domain, frequency-domain, and time-domain.

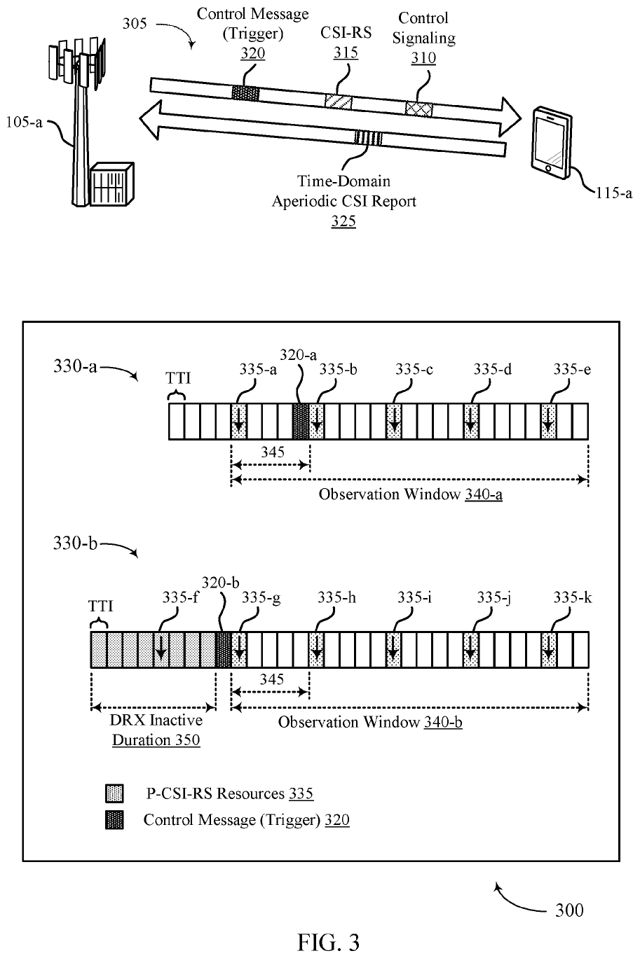

FIG. 3 illustrates an example of a wireless communications system 300 that supports buffer restriction for time-domain CSI reporting in accordance with one or more aspects of the present disclosure. In some examples, aspects of the wireless communications system 300 may implement, or be implemented by, aspects of the wireless communications system 100, the CSI reporting configuration 200, or both. In particular, the wireless communications system 300 may support signaling and configurations for time-domain CSI reporting, as described herein.

The wireless communications system 300 may include a network entity 105-a, and a UE 115-a, which may be examples of network entities 105 and UEs 115 as described with reference to FIG. 1. The UE 115-a may communicate with the network entity 105-a using a communication link 305, which may be an example of an NR or LTE link between the UEs 115-a and the network entity 105-a. In some cases, the communication link 305 between the UE 115-a and the network entity 105-a may include an example of an access link (e.g., Uu link) which may include bi-directional links that enable both uplink and downlink communication. For example, the UE 115-a may transmit uplink signals, such as uplink control signals or uplink data signals, to one or more components of the network entity 105-a using the communication link 305, and one or more components of the network entity 105-a may transmit downlink signals, such as downlink control signals or downlink data signals, to the UE 115-a using the communication link 305.

As described previously herein, the wireless communications system 300 may support signaling and configurations which enable the UE 115-a to report time-domain CSI for multiple time instances. In other words, the wireless communications system 300 may support techniques which enable the UE 115-a to transmit time-domain aperiodic CSI reports 325 associated with CSI measured at multiple points in time to enable the UE 115-a to report how CSI changes over time. In some aspects, the wireless communications system 300 may support CSI reporting for high/medium UE 115-a velocities by exploiting time-domain correlation/Doppler-domain information to assist downlink precoding, and to enable UE-reporting of time-domain channel properties measured via CSI-RS for tracking.

In particular, some wireless devices may be configured to transmit different types of CSI reports, including periodic CSI reports, semi-persistent CSI reports, and aperiodic CSI reports. For semi-persistent CSI reports may be conveyed on PUCCH resources (e.g., triggered by MAC-CE), conveyed on PUSCH resources (e.g., triggered by DCI), or both. Comparatively, aperiodic CSI reports are triggered by DCI and conveyed via PUSCH resources.

Each of the respective CSI reports may be determined based on different types of CSI-RSs, including periodic CSI-RSs, semi-persistent CSI-RSs, and aperiodic CSI-RSs. In other words, each respective type of CSI-RS may be used to generate different types of CSI reports. In particular, periodic CSI-RSs may support all three types of CSI reports, including periodic CSI reports, semi-persistent CSI reports, and aperiodic CSI reports. Comparatively, semi-persistent CSI-RSs may support semi-persistent CSI reports and aperiodic CSI reports, whereas aperiodic CSI-RSs may support only aperiodic CSI reports.

Due to the relatively large overhead associated with time-domain CSI reports (e.g., CSI reports which report CSI measurements over multiple time instances), such time-domain CSI reports may be limited to being conveyed via PUSCH resources. As such, the wireless communications system 300 may support techniques for transmitting time-domain CSI reports as aperiodic CSI reports and/or semi-persistent CSI reports transmitted via PUSCH (and triggered by DCI), where such aperiodic and semi-persistent CSI reports may be supported by all three types of CSI-RSs (e.g., periodic, semi-persistent, and aperiodic CSI-RSs)

However, periodic CSI-RSs configured with a potentially aperiodic report for time-domain/Doppler-domain CSI (e.g., RRC configures CSI-AperiodicTriggerState associated with this periodic CSI-RS and an aperiodic CSI report), UEs 115 may be expected to buffer a window of CSI-RS measurements/instances in case an aperiodic CSI report is triggered at any point. In other words, if a UE 115 is configured with a set of periodic CSI-RSs, the UE 115 may not know when an aperiodic CSI report based on the periodic CSI-RSs will be triggered. As such, the UE 115 may be expected to maintain a quantity of CSI measurements buffered in memory in case the UE 115 is triggered to transmit an aperiodic CSI report. However, buffering (e.g., storing) large quantities of CSI-RS measurements results in increased processing resources at the UE 115, increased cost and complexity associated with the memory, and wasted power used to buffer CSI-RS measurements in cases where aperiodic reports are not triggered.

Accordingly, the wireless communications system 300 may support techniques which enable the UE 115-a to buffer/store defined quantities of CSI-RS measurements for time-domain aperiodic CSI reporting. In other words, the UE 115-a of the wireless communications system 300 may be configured to buffer/store some quantity of CSI measurements measured at multiple points in time (e.g., “time-domain CSI”) to enable the UE 115-a to report how CSI changes over time. In particular, aspects of the present disclosure may support CSI reporting configurations which cause the UE 115-a to report time-domain CSI within an observation window, where the observation window starts relative to (e.g., based on) when the UE 115-a is triggered to provide an time-domain aperiodic CSI report, thereby limiting how many CSI measurements the UE is expected to buffer before the trigger for the CSI report is received.

For example, as shown in FIG. 3, the UE 115-a may receive, from the network entity 105-a, control signaling 310 indicating a CSI reporting configuration for transmitting time-domain CSI reports 325 (e.g., CSI reporting configuration for time-domain aperiodic CSI reporting). The control signaling 310 may include, but is not limited to, RRC signaling, DCI signaling, MAC-CE signaling, or any combination thereof.

The CSI reporting configuration may indicate time, frequency, and spatial resources usable for receiving CSI-RSs 315, transmitting CSI reports 325, or both. For example, as shown in the first and second implementations 330-a, 330-b illustrated in FIG. 3, the CSI reporting configuration may include a set of CSI-RS resources usable for transmitting/receiving periodic CSI-RS resources 335. In this example, the sets of periodic CSI-RS resources 335 illustrated in the first and second implementations 330 may be associated with respective periodicities 345. In additional or alternative implementations, as will be described in further detail herein, the UE 115-a may be configured with other types of CSI-RS resources, including semi-persistent CSI-RS resources, aperiodic CSI-RS resources, or both.

The legend illustrated in FIG. 3 shows slots/TTIs as including periodic CSI-RS resources 335 and/or a control message 320. However, it is to be understood that periodic CSI-RS resources 335, a control message 320, or both, may not span an entirety of a slot/TTI. In particular, each periodic CSI-RS resource 335, each control message 320, or both, may span one or more symbols within each slot/TTI illustrated in FIG. 3, and may not span an entirety of the respective slot/TTI.

In some aspects, the UE 115-a may receive, from the network entity 105-a, one or more CSI-RSs 315. In some aspects, the UE 115-a may receive the CSI-RSs 315 within a set of resources indicated via the control signaling 310 (e.g., within CSI-RS resources associated with the CSI reporting configuration). The CSI-RSs 315 may include periodic CSI-RSs, semi-persistent CSI-RSs, aperiodic CSI-RSs, or any combination thereof. For example, referring to the first implementation 330-a, the UE 115-a may receive periodic CSI-RS resources 335 within periodic CSI-RS resources associated with the CSI reporting configuration.

The UE 115-a may perform CSI measurements of the CSI-RSs 315 received from the network entity 105-a. In particular, the UE 115-a may perform CSI measurements on received CSI-RSs 315 in accordance with the CSI reporting configuration. In this regard, the UE 115-a may perform the CSI measurements at 415 based on receiving the control signaling 310, receiving the CSI-RSs 315, or both.

In some aspects, the UE 115-a may buffer (e.g., store) a quantity of CSI measurements in memory. The quantity of CSI measurements buffered/stored in memory may be based on the CSI reporting configuration indicated via the control signaling 310, based on the type of CSI-RS resources/CSI-RSs 315 received, or both.

For example, referring to the first implementation 330-a, in the context of aperiodic CSI reports 325 based on periodic CSI-RS resources 335, the UE 115-a may be expected to buffer no more than one CSI-RS observation (e.g., buffer no more than one CSI measurement). In such cases, CSI-RS buffering at the UE 115-a for time-domain aperiodic CSI reporting may include eTypeII CSI buffering. In this example, the UE 115-a may be configured to maintain a single CSI measurement buffered in memory, and may discard or overwrite previous CSI measurements as new CSI measurements become available. In other words, in some cases, the UE 115-a may be configured to maintain a most recent CSI measurement associated with a most recent CSI-RS resource/instance in memory in accordance with the CSI reporting configuration. In additional or alternative implementations, the CSI reporting configuration may cause the UE 115-a to buffer differing quantities of CSI measurements in memory (e.g., two, three, four, etc.).

In other cases, the UE 115-a may not be configured to maintain a buffer. For example, as shown in the second implementation 330-b, the UE 115-a may not be configured to maintain a buffer of CSI measurements while operating in an inactive duration 350 of a DRX cycle. In other words, the DRX cycle at the UE 115-a may be taken into account when determining a quantity of CSI measurements the UE 115-a is expected to buffer.

Moreover, the UE 115-a may not be configured to maintain a buffer in the context of aperiodic CSI reports 325 that are based on aperiodic and/or semi-persistent CSI-RSs 315. In cases for time-domain aperiodic CSI reports 325 based on aperiodic and/or semi-persistent CSI-RSs, the UE 115-a may not be expected to maintain a buffer due to the fact that all CSI-RS resources/instances are activated or transmitted after the triggering PDCCH (e.g., after a control message 320 triggering a time-domain aperiodic CSI report 325).

Further, in some implementations, the quantity of CSI measurements/instances the UE 115-a is expected to buffer may be based on a computational consumption at the UE 115-a. The computational consumption associated with the UE 115-a may be based on a quantity of occupied CSI processing units associated with the UE (e.g., how many concurrent, separate CSI measurement processes the UE is capable of performing), a quantity of CSI-RS ports/resources activated at the UE 115-a, or both. In particular, a UE 115-a may not be expected to buffer a quantity of CSI measurements which exceeds its computational consumption (e.g., UE 115-a is not expected to update a number of CSI reports exceeding a capability of the UE 115-a limited by a number of CSI processing units). Similarly, the UE 115-a may not be expected to have more active CSI-RS ports/resources than exceed its reported capability.

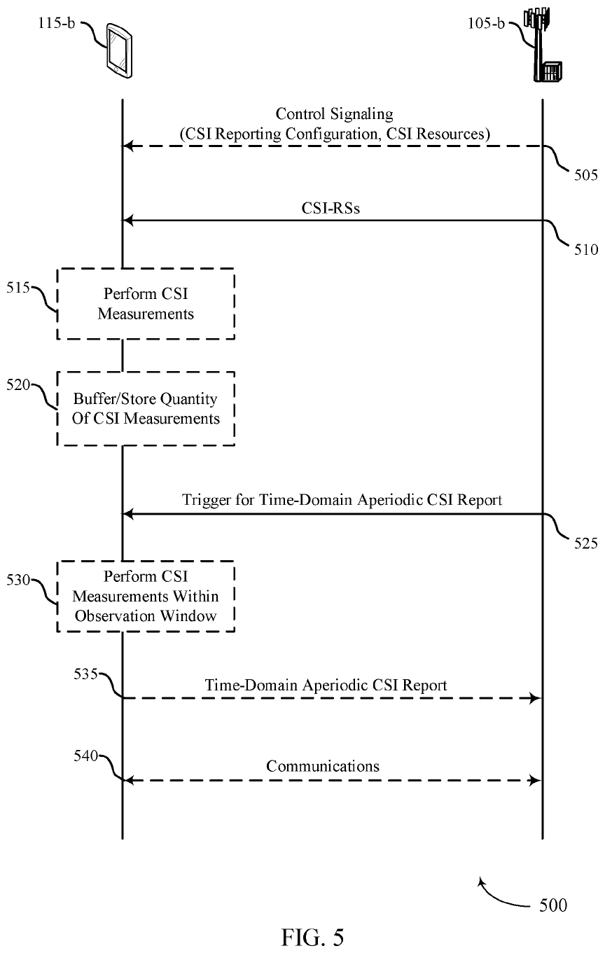

Limits on how many CSI measurements the UE 115-a is expected to buffer based on computational consumption will be further shown and described with reference to FIG. 5.

Continuing with reference to FIG. 3, the UE 115-a may receive a control message 320 that triggers the UE 115-a to provide a time-domain aperiodic CSI report 325 for indicating time-domain CSI associated with CSI-RS resources within an observation window 340. In other words, the UE 115-a may be triggered to measure CSI-RSs 315 (e.g., periodic CSI-RS resources 335) received via CSI-RS resources within an observation window 340, and transmit a time-domain aperiodic CSI report 325 based on the performed measurements.

The control message 320 triggering the time-domain aperiodic CSI report 325 may include a PDCCH message, such as a DCI message, a MAC-CE message, or both. The UE 115-a may receive (and the network entity 105-a may transmit/output) the control message 320 indicating the trigger for the time-domain aperiodic CSI report 325 based on receiving/transmitting the control signaling 310, receiving/transmitting the CSI-RSs 315, performing the CSI measurements, buffering the CSI measurements, or any combination thereof.

In some cases, the control message 320 providing the trigger for the aperiodic CSI report 325 may indicate a time duration, a quantity of CSI-RS resources, or both, associated with the observation window 340. For example, referring to the first implementation 330-a, the control message 320-a may indicate that the observation window 340-a for the triggered time-domain aperiodic CSI report 325 includes the next four periodic CSI-RS resources 335 (e.g., observation window includes periodic CSI-RS resources 335-b, 335-c, 335-d, 335-e). Similarly, referring to the second implementation 330-b, the control message 320-b may indicate that the observation window 340-b for the triggered time-domain aperiodic CSI report 325 includes the next eighteen TTIs or slots, which include a quantity of periodic CSI-RS resources 335 (e.g., observation window includes periodic CSI-RS 335-g, 335-h, 335-i, 335-j, 335-k).

The observation window 340-a associated with the triggered time-domain aperiodic CSI report 325 may include a time-domain codebook/basis including one or more subtimes or time intervals, where each subtime/time interval spans one or more slots or other TTIs, as shown in FIG. 3.

In some aspects, a beginning of the observation window 340 associated with the time-domain aperiodic CSI report 325 may be based on when the control message 320 providing the trigger for the time-domain aperiodic CSI report 325 is received. Moreover, in some cases, the control message 320 may indicate a start of the observation window 340. In the context of aperiodic CSI reports 325 of time-domain CSI with periodic CSI-RS resources 335, the associated CSI-RS resources/instances included within an observation window for the triggered time-domain CSI report 325 may begin with one CSI-RS resource/instance prior to the triggering PDCCH.

For example, referring to the first implementation 330-a, the observation window 340-a may include one CSI-RS resource prior to the time at which the trigger for the aperiodic CSI report 325 is received. Stated differently, the observation window 340-a may include one periodic CSI-RS resource 335-a prior to the control message 320-a. In this example, the observation window 340-a may include a quantity of CSI-RS resources after the control message 320-a providing the trigger (e.g., periodic CSI-RS resources 335-b, 335-c, 335-d, 335-e) plus one additional CSI-RS resource/instance prior to the control message 320-a (e.g., periodic CSI-RS resource 335-a) in the time domain.

In such cases, an offset between the control message 320-a triggering the aperiodic CSI report 325 and the preceding CSI-RS resource (e.g., CSI-RS resource 335-a of periodic CSI-RS) included within the observation window 340-a may be less than the periodicity 345 of the respective periodic CSI-RS resources 335. In other words, the offset between the last periodic CSI-RS resource 335-a and the control message 320-a should be less than or equal to the periodicity 345 associated with the periodic CSI-RS resources 335.

Comparatively, if there is no measured CSI-RS resource/instance prior to the control message 320 which exhibits an offset that is less than or equal to the periodicity 345, the observation window 340 may start with the CSI-RS resource that is no earlier than the slot/TTI in which the control message 320 is received. In other words, if the last CSI measurement was performed longer than the periodicity 345 prior to the control message 320, the observation window 340 may begin with the first CSI-RS resource (e.g., first CSI-RS resource) following the control message 320. In some cases, the condition where no CSI measurement satisfies the offset/periodicity 345 may be due to the UE 115-a operating in accordance with a DRX cycle (e.g., operating outside DRX active time).

For example, referring to the second implementation 330-b, the observation window 340-b may start after the control message 320-b triggering the aperiodic CSI report 325 is received in cases where the UE 115-a was operating in an inactive duration 350 of a DRX cycle prior to receiving the trigger. In this example, due to the fact that the UE 115-a was operating in the inactive duration 350, the UE 115-a may have been unable to perform a CSI measurement for the periodic CSI-RS resource 335-f. As such, the observation window 340-b may begin after the control message 320-b is received, as shown in the second implementation 330-b (e.g., the UE 115-b may postpone the observation window 340-b).

In cases where the UE 115-a is configured with a DRX cycle, an activity timer associated with the DRX cycle (e.g., configured drx-Inactivity Timer) should be no smaller than the respective observation window 340. Including a condition which prevents the inactivity timer from being smaller than the observation window 340 in the time domain may prevent the case where the UE 115-a does not perform any CSI measurements during the observation window 340, since the UE 115-a can be outside the DRX active time (e.g., within an inactive duration 350) after the inactivity timer expires. In other words, if the inactivity timer were smaller than the observation window 340, the inactivity timer may expire and the UE 115-a may re-enter an inactive duration 350 prior to performing measurements within the observation window 340. As such, ensuring the inactivity timer is at least as long as the observation window 340 may ensure that the UE 115-a is enabled the opportunity to perform CSI measurements within the observation window 340.

In some aspects, the UE 115-a may be configured with different types of CSI-RS resources (e.g., different CSI-RS resource sets) that are to be measured and reported within a single observation window 340. For example, in some cases, the UE 115-a may be configured with a set of periodic CSI-RS resources 335 and one or more aperiodic CSI-RS resources/instances, semi-persistent CSI-RS resources/instances, or both, within a single observation window. In such cases, the UE 115-a may be configured to perform measurements for the different types of CSI-RS resources (e.g., periodic and aperiodic, periodic and semi-persistent), and report the measurements within the same time-domain aperiodic CSI report 325. In such cases, the different types of CSI-RS resources/instances (e.g., different CSI-RS resource sets) may be configured with the same downlink spatial filter to enable the UE 115-a to combine the measurements across the different types.

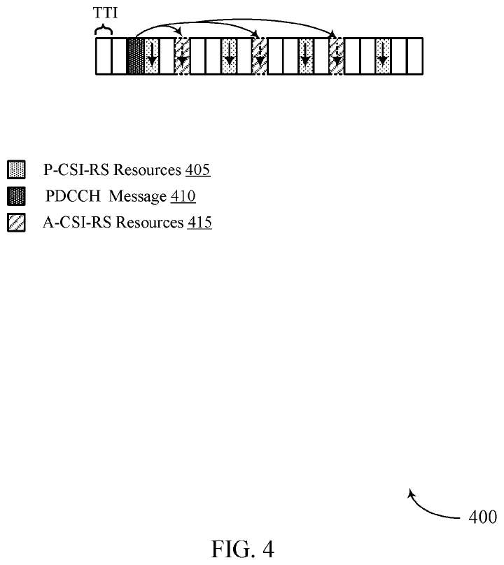

The ability to configure different types of CSI-RS resources/instances within the same observation window (e.g., periodic and aperiodic CSI-RS resources, or periodic and semi-persistent CSI-RS resources) will be described in further detail herein with respect to FIG. 4.

In some aspects, the observation window 340 may start after the control message 320 providing the trigger is received in the context of aperiodic CSI reports 325 based on aperiodic and/or semi-persistent CSI-RS resources. For example, in cases where the control message 320 indicates aperiodic CSI-RS resources, or activates semi-persistent CSI-RS resources, the observation window 340 may begin after the control message 320 is received (e.g., prior to the next CSI-RS resource). In such cases, because the aperiodic/semi-persistent CSI-RS observations naturally appear only after the triggering PDCCH (e.g., control message 320) is received, no buffer is needed. As such, the UE 115-a is not expected to buffer CSI measurements in memory, and the observation window 340 would begin after the triggering control message 320 is received.

In the context of aperiodic CSI-RS resources distributed over multiple slots/TTIs within the observation window, the control message 320 indicating the aperiodic CSI-RS resources may also configure or indicate different triggering offsets (e.g., different aperiodicTriggeringOffset) for the CSI-RSs within each respective CSI-RS resource set. For example, a control message 320 may activate aperiodic CSI-RS resources within an observation window such that all CSI-RS resources within the observation window appear only after the control message 320 is received (e.g., no periodic CSI-RS resources 335). In this example, the control message 320 may indicate that all the CSI-RS resources (e.g., all aperiodic CSI-RS resources) within the observation window 340 are transmitted with the same downlink spatial relationship/spatial filter so that the CSI-RS resources within the observation window 340 exhibit phase coherence for Doppler estimation. For instance, the control message 320 may re-purpose the existing parameter for CSI repetition (e.g., reuse parameter for repetition set to “ON”), where the UE 115-a is configured to interpret the parameter for Doppler CSI usage, as compared to the traditional usage of the parameter for analog beam management in FR2.

Moreover, in the context of semi-persistent CSI-RSs with a lasting duration, the control message 320 activating the semi-persistent CSI-RS resources may include an indication of a time interval (e.g., lasting duration) for the respective semi-persistent CSI-RS resources. In other words, if a control message 320 were to activate a set of semi-persistent CSI-RS resources that are to be measured within an observation window 340, the control message 320 may include a parameter indicating a time interval (e.g., lasting duration which may include, for example, tens of slots or other time duration) associated with the configuration of the CSI-RS resource or resource set.

Continuing with reference to FIG. 3, the UE 115-a may transmit the time-domain aperiodic CSI report 325 to the network entity 105-a. The time-domain aperiodic CSI report 325 may be generated based on CSI measurements performed during the observation window 340, and may thereby indicate how a relative quality of the channel between the UE 115-a and the network entity 105-a changes over time during the observation window 340.

For example, referring to the first implementation 330-a, the time-domain aperiodic CSI report 325 may indicate CSI measurements (and/or PMIs) associated with the periodic CSI-RS resources 335-a through 335-e within the observation window 340-a. Moreover, as will be described in further detail with respect to FIG. 4, in cases where the control message 320-a triggers aperiodic and/or semi-persistent CSI-RS resources within the observation window 340-a, the time-domain aperiodic CSI report 325 may indicate CSI measurements (and/or PMIs) associated with both the periodic CSI-RS resources 335 within the observation window 340-a, and the aperiodic/semi-persistent CSI-RS resources within the observation window 340-b.

Comparatively, referring to the second implementation 330-b, the time-domain aperiodic CSI report 325 may indicate CSI measurements (and/or PMIs) associated with the periodic CSI-RS resources 335-g through 335-k within the observation window 340-b. Moreover, in cases where the control message 320-b triggers aperiodic and/or semi-persistent CSI-RS resources within the observation window 340-b, the time-domain aperiodic CSI report 325 may indicate CSI measurements (and/or PMIs) associated with both the periodic CSI-RS resources 335 within the observation window 340-b, and the aperiodic/semi-persistent CSI-RS resources within the observation window 340-b.

Subsequently, the UE 115-a and the network entity 105-a may communicate with one another based on the time-domain CSI report 325. In particular, the network entity 105-a may determine and/or selectively modify one or more parameters used for wireless communications between the UE 115-a and the network entity 105-a based on the CSI report 325 (e.g., MCS, SCS, PMI).

Techniques described herein may be used to define observation windows 340 over which time-domain CSI is to be measured and reported via time-domain aperiodic CSI reports 325. By defining an observation window 340 for time-domain aperiodic CSI reporting, techniques described herein may limit a quantity of CSI measurements and associated information that the UE 115-a is expected to buffer or store in memory. As such, techniques described herein may reduce processing resources used to buffer large quantities of CSI measurements and reduce memory requirements at the UE 115-a. Moreover, by reducing a burden on processing resources, techniques described herein may reduce a power consumption at the UE 115-a, and reduce or prevent wasted processing resources in the event the UE 115-a is not triggered to perform an time-domain aperiodic CSI report 325.

FIG. 4 illustrates an example of a resource configuration 400 that supports buffer restriction for time-domain CSI reporting in accordance with one or more aspects of the present disclosure. Aspects of the resource configuration 400 may implement, or be implemented by, aspects of the wireless communications system 100, the CSI reporting configuration 200, the wireless communications system 300, or any combination thereof.

As described previously herein, in some aspects, to increase the number of CSI-RS resources/instances for time-domain CSI in a dynamic burst (denser in time-domain means higher Doppler resolution), two or more CSI-RS resource sets different CSI-RS types may be combined for the same time-domain aperiodic CSI report. In other words, the UE 115 may be configured to measure both periodic CSI-RS resources as well as aperiodic or semi-persistent CSI-RSs, and combine the measurements for the time-domain aperiodic CSI report. P/SP/A types can be combined for time-domain CSI report.

For example, as shown in the resource configuration 400, a UE 115 may be configured with a set of periodic CSI-RS resources 405 which are to be measured for time-domain aperiodic CSI reporting. The UE 115 may receive a control message (e.g., PDCCH message 410) that triggers a time-domain aperiodic CSI report, as described previously herein with respect to FIG. 3. In this regard, the UE 115 may be configured to identify a start of an observation window that is to be measured/monitored for the time-domain aperiodic CSI report. The PDCCH message 410 may include a DCI message, a MAC-CE message, or both.

In this example, the PDCCH message 410 may indicate a set of aperiodic CSI-RS resources 415 that are to be measured within the observation window for aperiodic CSI reporting. In this example, the UE 115 may be configured to measure the periodic CSI-RS resources 405 and the aperiodic CSI-RS resources 415 within the observation window, and combine the measurements for reporting via the time-domain aperiodic CSI report. In other words, the CSI report triggered by the PDCCH message 410 may be based on two separate CSI-RS resource sets: (1) a first CSI-RS resource set for the periodic CSI-RS resources 405, and (2) a second CSI-RS resource set for the aperiodic CSI-RS resources 415. The type of CSI instance/resource within each CSI-RS resource set may be configured and/or indicated by the network entity 105. In other words, the parameter resource Type included in “CSI-ResourceConfig” should be configured per each respective CSI-RS resource set.

In cases with multiple CSI-RS resource sets within the observation window, all the CSI-RS instances/resources within the respective CSI-RS resource sets should have a same downlink spatial filter. For example, the network entity 105 may indicate, via the PDCCH message 410, a downlink spatial filter associated with the aperiodic CSI-RS resources 415, where the indicated downlink spatial filter is the same as that used for the periodic CSI-RS resources 405. By utilizing the same downlink spatial filter across both the periodic CSI-RS resources 405 and the aperiodic CSI-RS resources 415, the UE 115 may be able to combine the measurements across the instances for the triggered time-domain aperiodic CSI report.

While the resource configuration 400 is described in the context of aperiodic CSI-RS resources 415, this is not to be regarded as a limitation of the present disclosure. For example, in additional or alternative implementations, the PDCCH message 410 may trigger or activate semi-persistent CSI-RS resources that are to be measured in addition to the periodic CSI-RS resources 405.

FIG. 5 illustrates an example of a process flow 500 that supports buffer restriction for time-domain CSI reporting in accordance with one or more aspects of the present disclosure. In some examples, aspects of the process flow 500 may implement, or be implemented by, aspects of the wireless communications system 100, the CSI reporting configuration 200, the wireless communications system 300, the resource configuration 400, or any combination thereof. In particular, the process flow 500 illustrates a UE 115-b configured to buffer a quantity of CSI measurements within an observation window for time-domain aperiodic CSI reports, as described with reference to FIGS. 1-4, among other aspects.

The process flow 500 may include a UE 115-b and a network entity 105-b, which may be examples of UEs 115 and network entities 105 as described with reference to FIGS. 1-4. For example, the UE 115-b and the network entity 105-b illustrated in FIG. 4 may be examples of the UE 115-a and the network entity 105-a, respectively, as illustrated in FIG. 3.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 505, the UE 115-b may receive, from the network entity 105-b, control signaling indicating a CSI reporting configuration for transmitting time-domain CSI reports (e.g., CSI reporting configuration for time-domain aperiodic CSI reporting). The control signaling may include, but is not limited to, RRC signaling, DCI signaling, MAC-CE signaling, or any combination thereof.

The CSI reporting configuration may indicate time, frequency, and spatial resources usable for receiving CSI-RSs, transmitting CSI reports, or both. For example, the control signaling may indicate a set of periodic CSI-RS resources that are to be measured by the UE 115-b for CSI reporting. In this example, the periodic CSI-RS resources may be associated with a periodicity. In additional or alternative implementations, the UE 115-b may be configured with other types of CSI-RS resources, including semi-persistent CSI-RS resources, aperiodic CSI-RS resources, or both.

At 510, the UE 115-b may receive, from the network entity 105-b, one or more CSI-RSs. In some aspects, the UE 115-b may receive the CSI-RSs within a set of resources indicated via the control signaling at 505 (e.g., within CSI-RS resources associated with the CSI reporting configuration). The CSI-RSs may include periodic CSI-RSs, semi-persistent CSI-RSs, aperiodic CSI-RSs, or any combination thereof.

At 515, the UE 115-b may perform CSI measurements of the CSI-RSs received at 510. In particular, the UE 115-b may perform CSI measurements on received CSI-RSs in accordance with the CSI reporting configuration. In this regard, the UE 115-b may perform the CSI measurements at 515 based on receiving the control signaling at 505, receiving the CSI-RSs at 510, or both.

At 520, the UE 115-b may buffer (e.g., store) a quantity of CSI measurements in memory. The quantity of CSI measurements buffered/stored in memory may be based on the CSI reporting configuration indicated via the control signaling at 505, based on the type of CSI-RS resources/CSI-RSs received, or both.

For example, as described previously herein with respect to the first implementation 330-a illustrated in FIG. 3, in the context of aperiodic CSI reports based on periodic CSI-RSs, the UE 115-b may be expected to buffer no more than one CSI-RS observation (e.g., buffer no more than one CSI measurement). In this example, the UE 115-b may be configured to maintain a single CSI measurement buffered in memory, and may discard or overwrite previous CSI measurements as new CSI measurements become available. In other words, in some cases, the UE 115-b may be configured to maintain a most recent CSI measurement associated with a most recent CSI-RS resource/instance in memory in accordance with the CSI reporting configuration. In additional or alternative implementations, the CSI reporting configuration may cause the UE 115-b to buffer differing quantities of CSI measurements in memory (e.g., two, three, four, etc.).

In other cases, the UE 115-b may not be configured to maintain a buffer. For example, as shown in the second implementation 330-b illustrated in FIG. 3, the UE 115-b may not be configured to maintain a buffer of CSI measurements while operating in an inactive duration of a DRX cycle. For example, the observation window may begin after the trigger is received in cases where the UE 115-b was operating in an inactive duration of a DRX cycle during a last CSI-RS resource prior to the control message in the time domain. Moreover, the UE 115-b may not be configured to maintain a buffer in the context of aperiodic CSI reports based on aperiodic and/or semi-persistent CSI-RSs. In such cases where the UE 115-b is not configured to maintain a buffer of CSI measurements, the UE 115-b may be configured to refrain from performing the CSI measurements at 515 and/or buffering the CSI measurements at 520.

At 525, the UE 115-b may receive a control message that triggers the UE 115-b to provide a time-domain aperiodic CSI report for indicating time-domain CSI associated with CSI-RS resources within an observation window. In other words, the UE 115-b may be triggered to measure CSI-RSs received via CSI-RS resources within an observation window, and transmit a time-domain aperiodic CSI report based on the performed measurements.

The control message triggering the time-domain aperiodic CSI report may include a PDCCH message, such as a DCI message, a MAC-CE message, or both. The UE 115-b may receive (and the network entity 105-b may transmit/output) the control message indicating the trigger for the time-domain aperiodic CSI report at 525 based on receiving/transmitting the control signaling at 505, receiving/transmitting the CSI-RSs at 510, performing the CSI measurements at 515, buffering the CSI measurements at 520, or any combination thereof.

In some cases, the control message providing the trigger for the aperiodic CSI report may indicate a time duration, a quantity of CSI-RS resources, or both, associated with the observation window. For example, the control message may indicate that the observation window for the triggered time-domain aperiodic CSI report includes the next ten slots, or the next fifteen CSI-RS resources.

In some aspects, a beginning of the observation window associated with the time-domain aperiodic CSI report may be based on when the control message providing the trigger for the time-domain aperiodic CSI report is received. For example, as shown and described with respect to the first implementation 330-a illustrated in FIG. 3, the observation window may include one CSI-RS resource prior to the time at which the trigger for the aperiodic CSI report is received. In other words, the beginning of the observation window may start prior to when the trigger is received such that the observation window includes a quantity of CSI-RS resources after the trigger plus one additional CSI-RS resource prior to the trigger in the time domain. In such cases, an offset between the control message triggering the aperiodic CSI report and the preceding CSI-RS resource included within the observation window may be less than the periodicity of the respective periodic CSI-RS resources.

Comparatively, as shown and described with respect to the second implementation 330-b illustrated in FIG. 3, the observation window may start after the trigger is received in cases where the UE 115-b was operating in an inactive duration of a DRX cycle prior to receiving the trigger, and was therefore unable to perform CSI measurements for the CSI-RS resource prior to the trigger.

Moreover, as described previously herein, the observation window may start after the trigger is received in the context of aperiodic CSI reports based on aperiodic and/or semi-persistent CSI-RS resources. For example, in cases where the control message at 525 indicates aperiodic CSI-RS resources, or activates semi-persistent CSI-RS resources, the observation window may begin after the trigger is received (e.g., prior to the next CSI-RS resource). Further, as described previously herein, and will be further described in FIG. 5, in some cases, the start of the observation window may be based on a computational consumption at the UE 115-b.

At 530, the UE 115-b may perform CSI measurements on CSI-RSs received via CSI-RS resources that occur within the observation window. As such, the UE 115-b may perform CSI measurements at 530 in accordance with the CSI reporting configuration, in accordance with the trigger received at 535, or both.

At 535, the UE 115-b may transmit the time-domain aperiodic CSI report to the network entity 105-b. The time-domain aperiodic CSI report may be generated based on CSI measurements performed during the observation window, and may thereby indicate how a relative quality of the channel between the UE 115-b and the network entity 105-b changes over time during the observation window. The UE 115-b may transmit the time-domain aperiodic CSI report at 535 based on receiving the control signaling at 505, receiving the CSI-RSs at 510, performing the CSI measurements at 515, buffering the CSI measurements at 520, receiving the control message triggering the aperiodic CSI report at 525, performing the CSI measurements within the observation window at 530, or any combination thereof.

In particular, the time-domain aperiodic CSI report may indicate CSI measurements performed during the observation window, PMIs determined based on CSI measurements performed during the observation window, or both. In this regard, the time-domain aperiodic CSI report may indicate CSI measurements (and/or associated PMIs) which were buffered/stored in memory at 520, as well as the CSI measurements performed at 530. For example, in cases where the observation window includes one CSI-RS resource prior to the trigger, the CSI measurement performed at 515 and stored at 520 prior to receiving the trigger may be included within the observation window. In this example, the time-domain CSI report at 535 may include the one CSI measurement buffered prior to the trigger at 520 plus the CSI measurements performed after the trigger at 530.

Comparatively, in cases where the observation window starts after receiving the trigger at 525, any CSI measurements performed/buffered prior to receiving the trigger would not be included within the observation window. Accordingly, in such cases, the CSI report at 535 may include only CSI measurements (and/or corresponding PMIs) which were performed after receiving the trigger and during the observation window at 530.

At 540, the UE 115-b and the network entity 105-b may communicate with one another based on the time-domain CSI report at 535. In particular, the network entity 105-b may determine and/or selectively modify one or more parameters used for wireless communications between the UE 115-b and the network entity 105-b based on the CSI report.

Techniques described herein may be used to define observation windows over which time-domain CSI is to be measured and reported via time-domain aperiodic CSI reports. By defining an observation window for time-domain aperiodic CSI reporting, techniques described herein may limit a quantity of CSI measurements and associated information that the UE 115-a is expected to buffer or store in memory. As such, techniques described herein may reduce processing resources used to buffer large quantities of CSI measurements and reduce memory requirements at the UE 115-a. Moreover, by reducing a burden on processing resources, techniques described herein may reduce a power consumption at the UE 115-a, and reduce or prevent wasted processing resources in the event the UE 115-a is not triggered to perform an time-domain aperiodic CSI report.

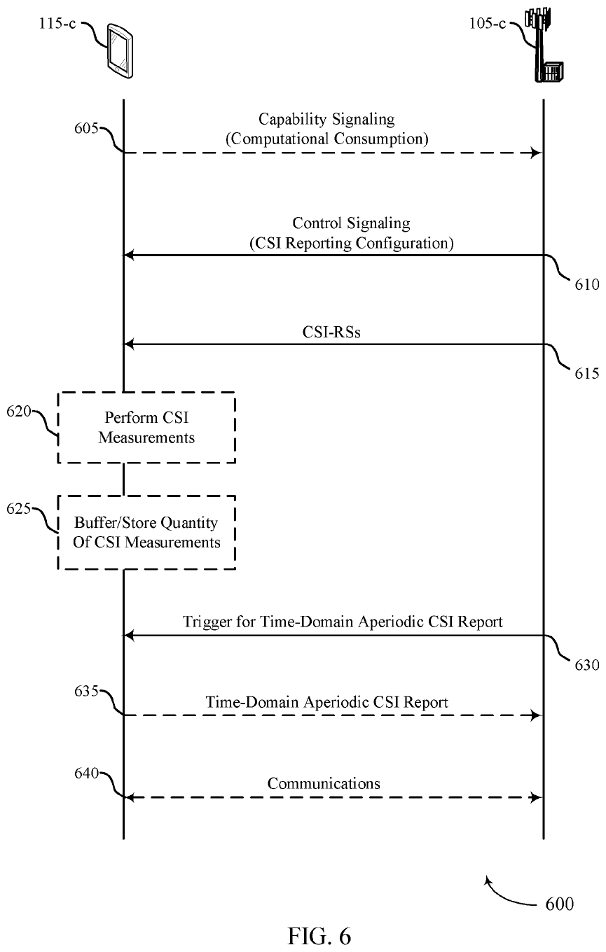

FIG. 6 illustrates an example of a process flow 600 that supports buffer restriction for time-domain CSI reporting in accordance with one or more aspects of the present disclosure. In some examples, aspects of the process flow 600 may implement, or be implemented by, aspects of the wireless communications system 100, the CSI reporting configuration 200, the wireless communications system 300, the resource configuration 400, the process flow 500, or any combination thereof. In particular, the process flow 600 illustrates a UE 115-c which buffers/stores a quantity of CSI measurements based on a computational consumption of the UE 115-c for time-domain aperiodic CSI reporting as described with reference to FIGS. 1-5, among other aspects.

The process flow 600 may include a UE 115-c and a network entity 105-c, which may be examples of UEs 115 and network entities 105 as described with reference to FIGS. 1-5. For example, the UE 115-c and the network entity 105-c illustrated in FIG. 6 may be examples of the UE 115-a and the network entity 105-a, respectively, as illustrated in FIG. 3.

In some examples, the operations illustrated in process flow 600 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

At 605, the UE 115-c may transmit capability signaling to the network entity 105-c, where the capability signaling is associated with a computational consumption at the UE 115-c. The computational consumption may indicate (or be associated with) how many concurrent, separate CSI measurement processes the UE 115-c is capable of performing (e.g., CSI processing units, active CSI-RS ports/resources).

For example, the capability signaling may indicate a computational consumption associated with the UE 115-c, where the computational consumption is associated with a quantity of occupied central processing units at the UE 115-c, a quantity of active channel state information reference signal ports at the UE 115-c, or both. As described previously herein, the computational consumption may determine (or be associated with) a quantity of CSI measurements the UE 115-c is expected to buffer for time-domain aperiodic CSI reports.

In some cases, the computational consumption associated with the UE 115-a may be based on a CSI processing unit occupation at the UE 115-c. In such cases, the computational consumption may be based on a number of occupied CPUs (O_{CPU}) for a CSI-RS resource set with Kₛ CSI-RS resources, where O_{CPU}=Kₛ. The CSI processing unit occupation duration may be based on the type of CSI report. For periodic and/or semi-persistent reports (excluding the first report for semi-persistent reporting), the CSI processing unit occupation duration may be based on the earliest one of CSI-RS, CSI-IM, and/or SSB, to the respective latest CSI-RS, CSI-IM, and/or SSB instance, for the CSI report. For aperiodic CSI reports, (including the first report for semi-persistent reporting), the CSI processing unit occupation duration may be based on the control message triggering the CSI report to the CSI report transmitted via PUSCH. Further, in such cases the computational consumption may be based on a scaling-up for a number of occupied CSI processing units (O_{CPU}) for a CSI-RS resource set with Kₛ CSI-RS resources, where O_{CPU}=Kₛ·α or [Kₛ·α], for α>1. For CSI processing unit occupation duration of aperiodic-like CSI report, the computational consumption may start prior to the triggering PDCCH, until the last symbol of the CSI report PUSCH.

Comparatively, in cases where the computational consumption of the UE 115-c is based on a quantity of active CSI-RS ports/resources, the computational consumption may be based on N for one CSI-RS referred N times by one or more report settings. Further, the computational consumption may be based on a scaling-up for the quantity of active CSI-RS ports/resources, where N·β or [N·β] for 1 CSI-RS referred N times by one or more report settings, where β>1. Additionally, the active duration (e.g., CSI processing unit occupation duration) may be based on the type of CSI-RS. For periodic CSI-RSs, the active duration is defined from RRC configuration to RRC release. For semi-persistent CSI-SRs, the active duration is defined from MAC-CE activation to deactivation, and for aperiodic CSI-RSs, the active duration is defined as from the triggering PDCCH to the PUSCH CSI report.

At 610, the network entity 105-c may output (e.g., transmit) control signaling to the UE 115-c, where the control signaling indicates a CSI reporting configuration for time-domain CSI reporting. The CSI reporting configuration may indicate one or more parameters or characteristics associated with CSI reporting, including resources (e.g., time/frequency/spatial resources) for receiving CSI-RSs that are to be measured, transmitting CSI reports, or both. The control signaling may include RRC signaling, DCI signaling, MAC-CE signaling, or any combination thereof.

In some cases, the network entity 105-c may transmit the control signaling indicating the CSI reporting configuration based on obtaining (e.g., receiving) the capability signaling at 605. For example, the CSI reporting configuration may acknowledge the computational consumption indicated via the capability signaling at 605. Additionally, or alternatively, the CSI reporting configuration indicated via the control signaling may indicate a quantity of CSI measurements the UE 115-c is expected to buffer for time-domain aperiodic CSI reports, where the quantity of CSI measurements is based on (e.g., does not exceed) the computational consumption at the UE 115-c.

At 615, the network entity 105-b may output (e.g., transmit) one or more CSI-RSs. The network entity 105-b may transmit (and the UE 115-b may receive) the CSI-RSs based on receiving/transmitting the capability signaling at 605, transmitting/receiving the control signaling at 610, or both. For example, the network entity 105-c may transmit the CSI-RSs at 615 within resources indicated via the CSI reporting configuration signaled via the control signaling at 610.

At 620, the UE 115-b may perform measurements based on the received CSI-RSs. In particular, the UE 115-c may perform CSI measurements on received CSI-RSs in accordance with the CSI reporting configuration. In this regard, the UE 115-b may be configured to perform the measurements at 620 based on transmitting the capability signaling at 605, receiving the control signaling at 610, receiving the CSI-RSs at 615, or any combination thereof.

At 625, the UE 115-c may buffer (e.g., store) a quantity of CSI measurements in memory. The quantity of CSI measurements buffered/stored in memory may be based on the computational consumption at the UE 115-c which was indicated via capability signaling at 605, the CSI reporting configuration at 610, or both. In particular, the UE 115-c may buffer/store a quantity of CSI measurements in memory such that the quantity of buffered/stored CSI measurements does not exceed the computational consumption at the UE 115-c.

In some cases, the UE 115-c may maintain the quantity of CSI measurements in memory, where old CSI measurements stored in the buffer are removed or deleted to accommodate new CSI measurements. In other words, the UE 115-c may overwrite old CSI measurements with new CSI measurements such that the memory stores a quantity of CSI measurements corresponding to a most recent set of CSI-RS resources measured by the UE 115-c.

At 630, the UE 115-c may receive a control message that triggers the UE 115-c to provide a time-domain aperiodic CSI report for indicating time-domain CSI information. The control message triggering the time-domain CSI report may include PDCCH message, such as a DCI message, a MAC-CE message, or both.

The UE 115-c may receive (and the network entity 105-c may transmit/output) the control message triggering the CSI report based on transmitting/receiving the capability signaling at 605, receiving/transmitting the control signaling at 610, receiving/transmitting the CSI-RSs at 615, performing the CSI measurements at 620, buffering the quantity of CSI measurements at 625, or any combination thereof.

At 635, the UE 115-c may transmit the time-domain aperiodic CSI report to the network entity 105-c. In particular, the UE 115-c may transmit the time-domain aperiodic CSI report in accordance with the CSI reporting configuration and the computational consumption at the UE 115-c. For example, the time-domain aperiodic CSI report may include the quantity of CSI measurements buffered in memory at the UE 115-c.

In this regard, the UE 115-c may transmit (and the network entity 105-c may obtain/receive) the time-domain aperiodic CSI report at 635 based on transmitting/receiving the capability signaling at 605, receiving/transmitting the control signaling at 610, receiving/transmitting the CSI-RSs at 615, performing the measurements at 620, buffering the quantity of CSI measurements at 625, receiving the trigger at 630, or any combination thereof. For example, the UE 115-c may transmit the time-domain aperiodic CSI report via a set of resources indicated via the control signaling, the control message including the trigger, or both.

At 640, the UE 115-c and the network entity 105-c may communicate with one another based on the time-domain CSI report at 635. In particular, the network entity 105-c may determine and/or selectively modify one or more parameters used for wireless communications between the UE 115-c and the network entity 105-c based on the CSI report.

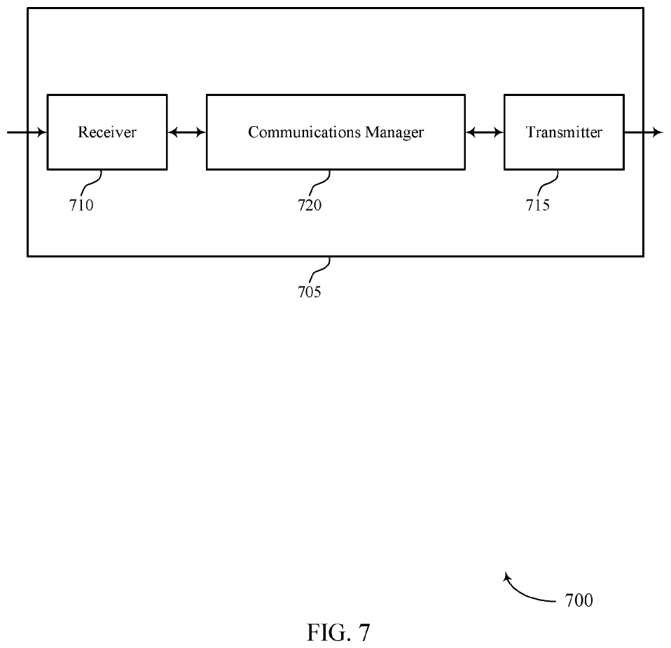

FIG. 7 shows a block diagram 700 of a device 705 that supports buffer restriction for time-domain CSI reporting in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to buffer restriction for time-domain CSI reporting). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to buffer restriction for time-domain CSI reporting). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of buffer restriction for time-domain CSI reporting as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving, from a network entity, a control message triggering the UE to provide a time-domain A-CSI report for indicating time-domain CSI associated with CSI-RS resources within an observation window, where a beginning of the observation window is based on when the control message is received. The communications manager 720 may be configured as or otherwise support a means for performing measurements of CSI reference signals received via the CSI-RS resources that occur within the observation window. The communications manager 720 may be configured as or otherwise support a means for transmitting, to the network entity and based on the control message, the time-domain A-CSI report indicating measured time-domain CSI associated with the observation window, where the measured time-domain CSI is based on the measurements.

Additionally, or alternatively, the communications manager 720 may support wireless communication at a UE in accordance with examples as disclosed herein. For example, the communications manager 720 may be configured as or otherwise support a means for receiving, from a network entity, control signaling indicating a CSI reporting configuration for time-domain CSI reporting. The communications manager 720 may be configured as or otherwise support a means for performing a quantity of measurements of a set of multiple CSI reference signals in accordance with the CSI reporting configuration, where the quantity of measurements is based on a computational consumption associated with the UE, and where the quantity of measurements are buffered in memory. The communications manager 720 may be configured as or otherwise support a means for receiving, from the network entity, a control message triggering the UE to provide a time-domain A-CSI report for indicating time-domain CSI. The communications manager 720 may be configured as or otherwise support a means for transmitting the time-domain A-CSI report to the network entity based on the control message, the time-domain A-CSI report indicating the quantity of measurements buffered in memory.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for defining observation windows over which time-domain CSI is to be measured and reported via time-domain aperiodic CSI reports. By defining an observation window for time-domain aperiodic CSI reporting, techniques described herein may limit a quantity of CSI measurements and associated information that UEs 115 are expected to buffer or store in memory. As such, techniques described herein may reduce processing resources used to buffer large quantities of CSI measurements and reduce memory requirements at the respective UEs 115. Moreover, by reducing a burden on processing resources, techniques described herein may reduce a power consumption at the UEs 115, and reduce or prevent wasted processing resources in the event the UEs 115 are not triggered to perform an time-domain aperiodic CSI report.

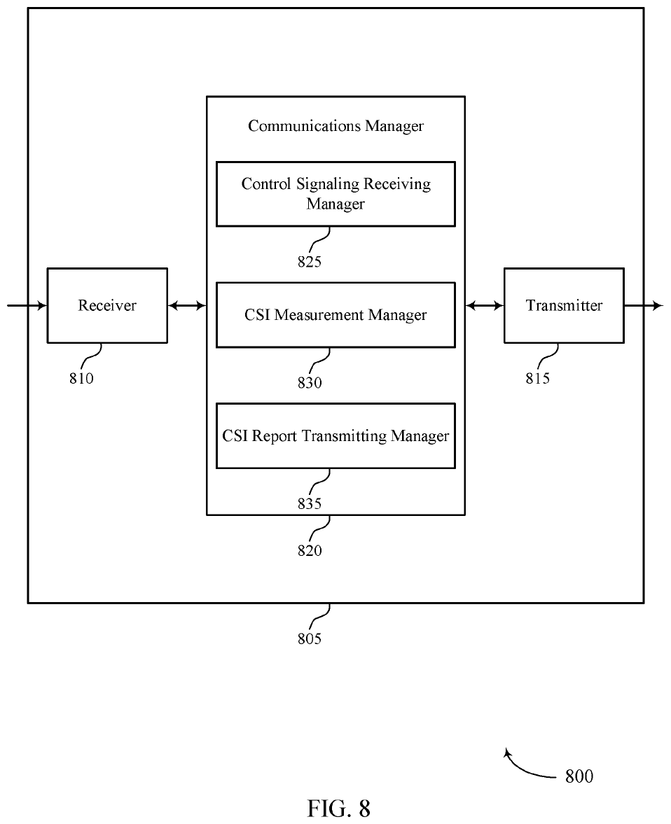

FIG. 8 shows a block diagram 800 of a device 805 that supports buffer restriction for time-domain CSI reporting in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to buffer restriction for time-domain CSI reporting). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to buffer restriction for time-domain CSI reporting). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of buffer restriction for time-domain CSI reporting as described herein. For example, the communications manager 820 may include a control signaling receiving manager 825, a CSI measurement manager 830, a CSI report transmitting manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The control signaling receiving manager 825 may be configured as or otherwise support a means for receiving, from a network entity, a control message triggering the UE to provide a time-domain A-CSI report for indicating time-domain CSI associated with CSI-RS resources within an observation window, where a beginning of the observation window is based on when the control message is received. The CSI measurement manager 830 may be configured as or otherwise support a means for performing measurements of CSI reference signals received via the CSI-RS resources that occur within the observation window. The CSI report transmitting manager 835 may be configured as or otherwise support a means for transmitting, to the network entity and based on the control message, the time-domain A-CSI report indicating measured time-domain CSI associated with the observation window, where the measured time-domain CSI is based on the measurements.

Additionally, or alternatively, the communications manager 820 may support wireless communication at a UE in accordance with examples as disclosed herein. The control signaling receiving manager 825 may be configured as or otherwise support a means for receiving, from a network entity, control signaling indicating a CSI reporting configuration for time-domain CSI reporting. The CSI measurement manager 830 may be configured as or otherwise support a means for performing a quantity of measurements of a set of multiple CSI reference signals in accordance with the CSI reporting configuration, where the quantity of measurements is based on a computational consumption associated with the UE, and where the quantity of measurements are buffered in memory. The control signaling receiving manager 825 may be configured as or otherwise support a means for receiving, from the network entity, a control message triggering the UE to provide a time-domain A-CSI report for indicating time-domain CSI. The CSI report transmitting manager 835 may be configured as or otherwise support a means for transmitting the time-domain A-CSI report to the network entity based on the control message, the time-domain A-CSI report indicating the quantity of measurements buffered in memory.

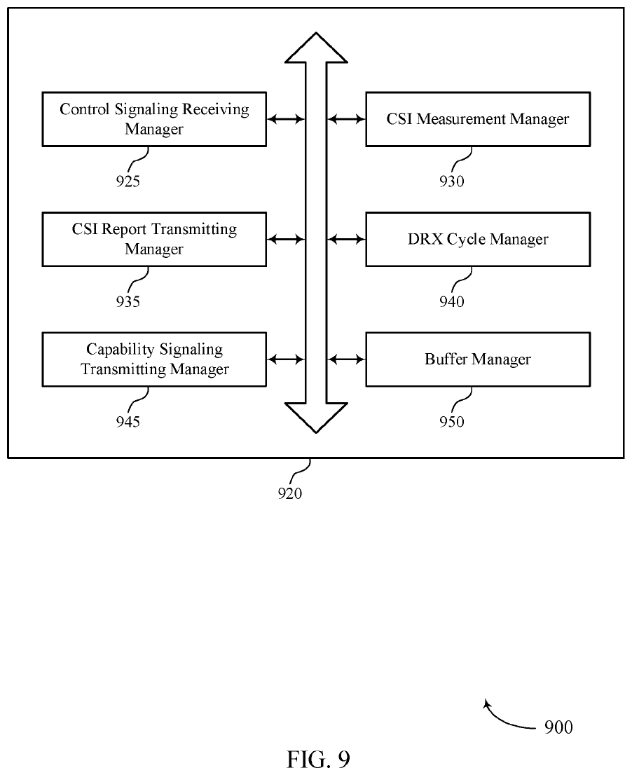

FIG. 9 shows a block diagram 900 of a communications manager 920 that supports buffer restriction for time-domain CSI reporting in accordance with one or more aspects of the present disclosure. The communications manager 920 may be an example of aspects of a communications manager 720, a communications manager 820, or both, as described herein. The communications manager 920, or various components thereof, may be an example of means for performing various aspects of buffer restriction for time-domain CSI reporting as described herein. For example, the communications manager 920 may include a control signaling receiving manager 925, a CSI measurement manager 930, a CSI report transmitting manager 935, a DRX cycle manager 940, a capability signaling transmitting manager 945, a buffer manager 950, or any combination thereof. Each of these components may communicate, directly or indirectly, with one another (e.g., via one or more buses).

The communications manager 920 may support wireless communication at a UE in accordance with examples as disclosed herein. The control signaling receiving manager 925 may be configured as or otherwise support a means for receiving, from a network entity, a control message triggering the UE to provide a time-domain A-CSI report for indicating time-domain CSI associated with CSI-RS resources within an observation window, where a beginning of the observation window is based on when the control message is received. The CSI measurement manager 930 may be configured as or otherwise support a means for performing measurements of CSI reference signals received via the CSI-RS resources that occur within the observation window. The CSI report transmitting manager 935 may be configured as or otherwise support a means for transmitting, to the network entity and based on the control message, the time-domain A-CSI report indicating measured time-domain CSI associated with the observation window, where the measured time-domain CSI is based on the measurements.

In some examples, the CSI measurement manager 930 may be configured as or otherwise support a means for performing an additional measurement of an additional CSI reference signal received within an additional CSI-RS resource that occurs prior to receiving the control message, where the observation window includes the additional CSI-RS resource. In some examples, the CSI report transmitting manager 935 may be configured as or otherwise support a means for transmitting the time-domain A-CSI report including the measured time-domain CSI that is based on the additional measurement.

In some examples, the control signaling receiving manager 925 may be configured as or otherwise support a means for receiving control signaling indicating a set of multiple periodic CSI-RS resources including the CSI-RS resources and the additional CSI-RS resource, where receiving the control message, performing the measurements on the CSI reference signals received via the CSI-RS resources, performing the additional measurement, or any combination thereof, is based on the control signaling. In some examples, the set of multiple periodic CSI-RS resources is associated with a periodicity. In some examples, an offset between the additional CSI-RS resource and the control message is less than the periodicity.

In some examples, the buffer manager 950 may be configured as or otherwise support a means for storing or buffering the additional measurement in memory in accordance with a CSI reporting configuration, where the UE stores or buffers in memory a most recent CSI reference signal measurement based on the CSI reporting configuration, where the additional measurement is the most recent CSI reference signal measurement that is stored or buffered in memory.

In some examples, the DRX cycle manager 940 may be configured as or otherwise support a means for operating in accordance with an inactive duration of a DRX cycle during a last CSI-RS resource that is prior to the control message in a time domain, where the observation window begins after receiving the control message based on operating in accordance with the inactive duration of the DRX cycle.

In some examples, an inactivity timer associated with the DRX cycle is greater than or equal to the observation window in a time domain. In some examples, the CSI-RS resources within the observation window include A-CSI-RS resources, semi-persistent CSI-RS resources, or both. In some examples, the observation window begins after receiving the control message.

In some examples, the control signaling receiving manager 925 may be configured as or otherwise support a means for receiving, via the control message, an indication of the CSI-RS resources within the observation window and an indication of a downlink spatial filter associated with each of the CSI-RS resources, the CSI-RS resources including one or more A-CSI-RS resources, where performing the measurements on the CSI reference signals is based on receiving the indication of the downlink spatial filter.

In some examples, the CSI-RS resources are associated with a semi-persistent CSI-RS, and the control signaling receiving manager 925 may be configured as or otherwise support a means for receiving, via the control message, an indication of a time duration associated with the CSI-RS, where the measurements are performed on the CSI reference signals within the time duration and within the observation window.

In some examples, the control signaling receiving manager 925 may be configured as or otherwise support a means for receiving control signaling indicating a first set of CSI-RS resources including the CSI-RS resources, the first set of CSI-RS resources including periodic resources, where performing the measurements of the CSI reference signals is based on receiving the control signaling. In some examples, the control signaling receiving manager 925 may be configured as or otherwise support a means for receiving, via the control message, an indication of a second set of CSI-RS resources within the observation window, the second set of CSI-RS resources including aperiodic resources, semi-persistent resources, or both. In some examples, the CSI measurement manager 930 may be configured as or otherwise support a means for performing additional measurements of the second set of CSI-RS resources within the observation window based on the control message, where the time-domain CSI is based on the measurements and the additional measurements.

In some examples, the first set of CSI-RS resources and the second set of CSI-RS resources are associated with a same downlink spatial filter. In some examples, the control message includes a PDCCH message.

Additionally, or alternatively, the communications manager 920 may support wireless communication at a UE in accordance with examples as disclosed herein. In some examples, the control signaling receiving manager 925 may be configured as or otherwise support a means for receiving, from a network entity, control signaling indicating a CSI reporting configuration for time-domain CSI reporting. In some examples, the CSI measurement manager 930 may be configured as or otherwise support a means for performing a quantity of measurements of a set of multiple CSI reference signals in accordance with the CSI reporting configuration, where the quantity of measurements is based on a computational consumption associated with the UE, and where the quantity of measurements are buffered in memory. In some examples, the control signaling receiving manager 925 may be configured as or otherwise support a means for receiving, from the network entity, a control message triggering the UE to provide a time-domain A-CSI report for indicating time-domain CSI. In some examples, the CSI report transmitting manager 935 may be configured as or otherwise support a means for transmitting the time-domain A-CSI report to the network entity based on the control message, the time-domain A-CSI report indicating the quantity of measurements buffered in memory.

In some examples, the capability signaling transmitting manager 945 may be configured as or otherwise support a means for transmitting, to the network entity, capability signaling associated with the computational consumption at the UE, where receiving the control signaling, performing the quantity of measurements, or both, is based on the capability signaling. In some examples, the computational consumption is associated with a quantity of occupied central processing units at the UE, a quantity of active CSI reference signal ports at the UE, or both.

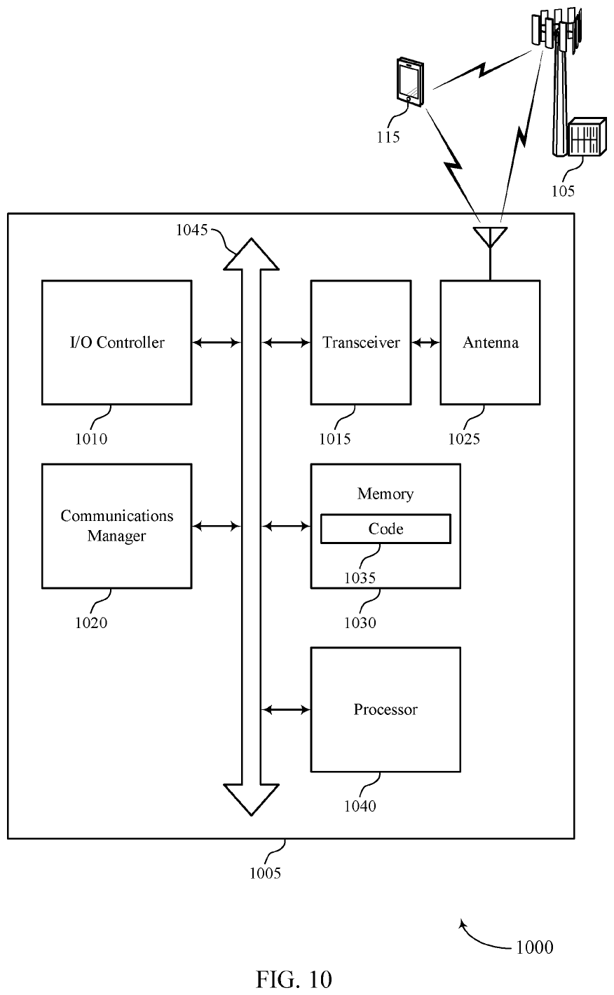

FIG. 10 shows a diagram of a system 1000 including a device 1005 that supports buffer restriction for time-domain CSI reporting in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting buffer restriction for time-domain CSI reporting). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving, from a network entity, a control message triggering the UE to provide a time-domain A-CSI report for indicating time-domain CSI associated with CSI-RS resources within an observation window, where a beginning of the observation window is based on when the control message is received. The communications manager 1020 may be configured as or otherwise support a means for performing measurements of CSI reference signals received via the CSI-RS resources that occur within the observation window. The communications manager 1020 may be configured as or otherwise support a means for transmitting, to the network entity and based on the control message, the time-domain A-CSI report indicating measured time-domain CSI associated with the observation window, where the measured time-domain CSI is based on the measurements.

Additionally, or alternatively, the communications manager 1020 may support wireless communication at a UE in accordance with examples as disclosed herein. For example, the communications manager 1020 may be configured as or otherwise support a means for receiving, from a network entity, control signaling indicating a CSI reporting configuration for time-domain CSI reporting. The communications manager 1020 may be configured as or otherwise support a means for performing a quantity of measurements of a set of multiple CSI reference signals in accordance with the CSI reporting configuration, where the quantity of measurements is based on a computational consumption associated with the UE, and where the quantity of measurements are buffered in memory. The communications manager 1020 may be configured as or otherwise support a means for receiving, from the network entity, a control message triggering the UE to provide a time-domain A-CSI report for indicating time-domain CSI. The communications manager 1020 may be configured as or otherwise support a means for transmitting the time-domain A-CSI report to the network entity based on the control message, the time-domain A-CSI report indicating the quantity of measurements buffered in memory.

By including or configuring the communications manager 1020 in accordance with examples as described herein, the device 1005 may support techniques for defining observation windows over which time-domain CSI is to be measured and reported via time-domain aperiodic CSI reports. By defining an observation window for time-domain aperiodic CSI reporting, techniques described herein may limit a quantity of CSI measurements and associated information that UEs 115 are expected to buffer or store in memory. As such, techniques described herein may reduce processing resources used to buffer large quantities of CSI measurements and reduce memory requirements at the respective UEs 115. Moreover, by reducing a burden on processing resources, techniques described herein may reduce a power consumption at the UEs 115, and reduce or prevent wasted processing resources in the event the UEs 115 are not triggered to perform an time-domain aperiodic CSI report.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of buffer restriction for time-domain CSI reporting as described herein, or the processor 1040 and the memory 1030 may be otherwise configured to perform or support such operations.

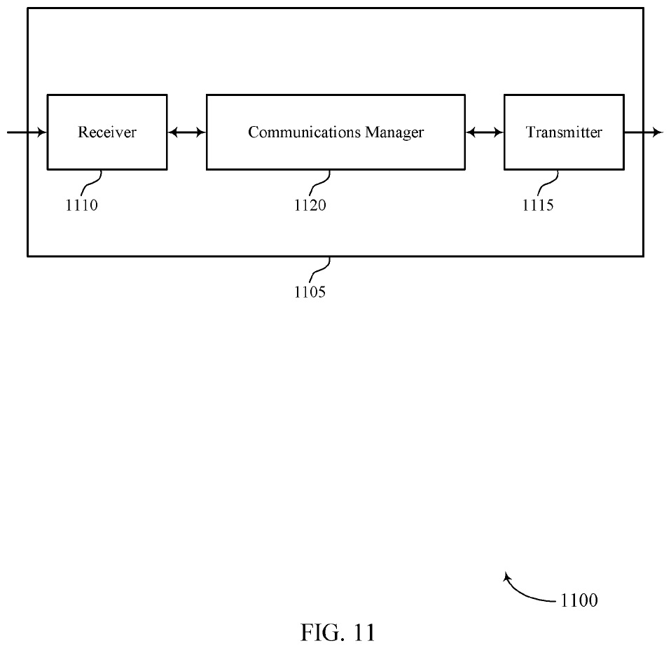

FIG. 11 shows a block diagram 1100 of a device 1105 that supports buffer restriction for time-domain CSI reporting in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of buffer restriction for time-domain CSI reporting as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting, to a UE, a control message triggering the UE to provide a time-domain A-CSI report for indicating time-domain CSI associated with CSI-RS resources within an observation window, where a beginning of the observation window is based on when the control message is received. The communications manager 1120 may be configured as or otherwise support a means for transmitting CSI reference signals via the CSI-RS resources that occur within the observation window. The communications manager 1120 may be configured as or otherwise support a means for receiving, from the UE and based on transmitting the CSI reference signals, the time-domain A-CSI report indicating measured time-domain CSI associated with the observation window, where the measured time-domain CSI is based on the CSI reference signals.

Additionally, or alternatively, the communications manager 1120 may support wireless communication at a network entity in accordance with examples as disclosed herein. For example, the communications manager 1120 may be configured as or otherwise support a means for transmitting, to a UE, control signaling indicating a CSI reporting configuration for time-domain CSI reporting. The communications manager 1120 may be configured as or otherwise support a means for transmitting a set of multiple CSI reference signals in accordance with the CSI reporting configuration. The communications manager 1120 may be configured as or otherwise support a means for transmitting a control message triggering the UE to provide a time-domain A-CSI report for indicating time-domain CSI. The communications manager 1120 may be configured as or otherwise support a means for receiving the time-domain A-CSI report based on the control message, the time-domain A-CSI report indicating a quantity of measurements performed on the set of multiple CSI reference signals, where the quantity of measurements is based on a computational consumption associated with the UE.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for defining observation windows over which time-domain CSI is to be measured and reported via time-domain aperiodic CSI reports. By defining an observation window for time-domain aperiodic CSI reporting, techniques described herein may limit a quantity of CSI measurements and associated information that UEs 115 are expected to buffer or store in memory. As such, techniques described herein may reduce processing resources used to buffer large quantities of CSI measurements and reduce memory requirements at the respective UEs 115. Moreover, by reducing a burden on processing resources, techniques described herein may reduce a power consumption at the UEs 115, and reduce or prevent wasted processing resources in the event the UEs 115 are not triggered to perform an time-domain aperiodic CSI report.

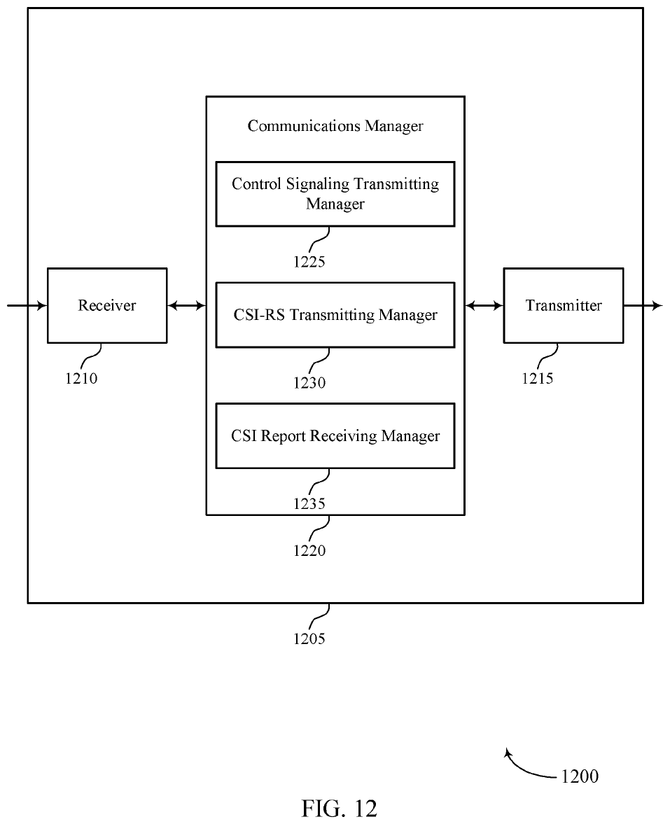

FIG. 12 shows a block diagram 1200 of a device 1205 that supports buffer restriction for time-domain CSI reporting in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of buffer restriction for time-domain CSI reporting as described herein. For example, the communications manager 1220 may include a control signaling transmitting manager 1225, a CSI-RS transmitting manager 1230, a CSI report receiving manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The control signaling transmitting manager 1225 may be configured as or otherwise support a means for transmitting, to a UE, a control message triggering the UE to provide a time-domain A-CSI report for indicating time-domain CSI associated with CSI-RS resources within an observation window, where a beginning of the observation window is based on when the control message is received. The CSI-RS transmitting manager 1230 may be configured as or otherwise support a means for transmitting CSI reference signals via the CSI-RS resources that occur within the observation window. The CSI report receiving manager 1235 may be configured as or otherwise support a means for receiving, from the UE and based on transmitting the CSI reference signals, the time-domain A-CSI report indicating measured time-domain CSI associated with the observation window, where the measured time-domain CSI is based on the CSI reference signals.

Additionally, or alternatively, the communications manager 1220 may support wireless communication at a network entity in accordance with examples as disclosed herein. The control signaling transmitting manager 1225 may be configured as or otherwise support a means for transmitting, to a UE, control signaling indicating a CSI reporting configuration for time-domain CSI reporting. The CSI-RS transmitting manager 1230 may be configured as or otherwise support a means for transmitting a set of multiple CSI reference signals in accordance with the CSI reporting configuration. The control signaling transmitting manager 1225 may be configured as or otherwise support a means for transmitting a control message triggering the UE to provide a time-domain A-CSI report for indicating time-domain CSI. The CSI report receiving manager 1235 may be configured as or otherwise support a means for receiving the time-domain A-CSI report based on the control message, the time-domain A-CSI report indicating a quantity of measurements performed on the set of multiple CSI reference signals, where the quantity of measurements is based on a computational consumption associated with the UE.

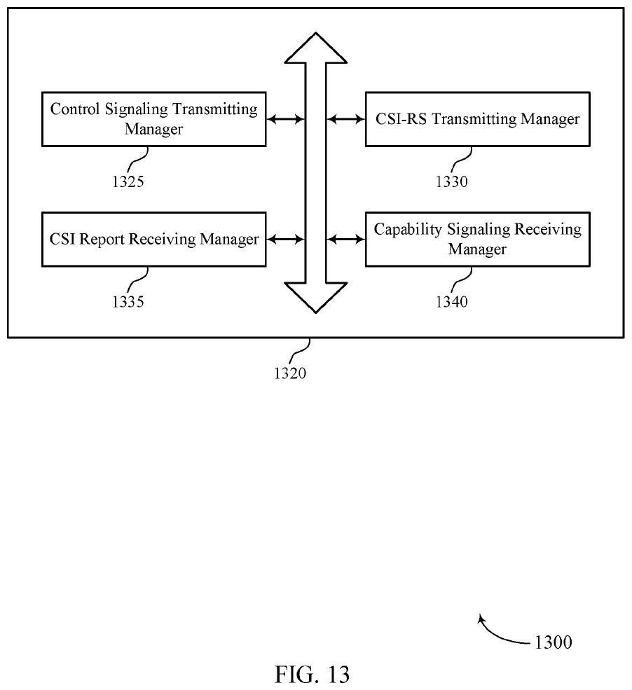

FIG. 13 shows a block diagram 1300 of a communications manager 1320 that supports buffer restriction for time-domain CSI reporting in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of buffer restriction for time-domain CSI reporting as described herein. For example, the communications manager 1320 may include a control signaling transmitting manager 1325, a CSI-RS transmitting manager 1330, a CSI report receiving manager 1335, a capability signaling receiving manager 1340, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The control signaling transmitting manager 1325 may be configured as or otherwise support a means for transmitting, to a UE, a control message triggering the UE to provide a time-domain A-CSI report for indicating time-domain CSI associated with CSI-RS resources within an observation window, where a beginning of the observation window is based on when the control message is received. The CSI-RS transmitting manager 1330 may be configured as or otherwise support a means for transmitting CSI reference signals via the CSI-RS resources that occur within the observation window. The CSI report receiving manager 1335 may be configured as or otherwise support a means for receiving, from the UE and based on transmitting the CSI reference signals, the time-domain A-CSI report indicating measured time-domain CSI associated with the observation window, where the measured time-domain CSI is based on the CSI reference signals.

In some examples, the CSI-RS transmitting manager 1330 may be configured as or otherwise support a means for transmitting an additional CSI reference signal via an additional CSI-RS resource that occurs prior to transmitting the control message, where the observation window includes the additional CSI-RS resource. In some examples, the CSI report receiving manager 1335 may be configured as or otherwise support a means for receiving the time-domain A-CSI report including the measured time-domain CSI that is based on the additional CSI reference signal.

In some examples, the control signaling transmitting manager 1325 may be configured as or otherwise support a means for transmitting control signaling indicating a set of multiple periodic CSI-RS resources including the CSI-RS resources and the additional CSI-RS resource, where transmitting the control message, transmitting the CSI reference signals via the CSI-RS resources, transmitting the additional CSI reference signal, or any combination thereof, is based on the control signaling.

In some examples, the set of multiple periodic CSI-RS resources is associated with a periodicity. In some examples, an offset between the additional CSI-RS resource and the control message is less than the periodicity. In some examples, the observation window begins after receiving the control message based on a DRX cycle at the UE. In some examples, an inactivity timer associated with the DRX cycle is greater than or equal to the observation window in a time domain. In some examples, the CSI-RS resources within the observation window include A-CSI-RS resources, semi-persistent CSI-RS resources, or both. In some examples, the observation window begins after transmitting the control message.

In some examples, the control signaling transmitting manager 1325 may be configured as or otherwise support a means for transmitting, via the control message, an indication of the CSI-RS resources within the observation window and an indication of a downlink spatial filter associated with each of the CSI-RS resources, the CSI-RS resources including one or more A-CSI-RS resources, where transmitting the CSI reference signals is based on the downlink spatial filter.

In some examples, the CSI-RS resources are associated with a semi-persistent CSI-RS, and the control signaling transmitting manager 1325 may be configured as or otherwise support a means for transmitting, via the control message, an indication of a time duration associated with the semi-persistent CSI-RS, where the CSI reference signals are transmitted within the time duration and within the observation window.

In some examples, the control signaling transmitting manager 1325 may be configured as or otherwise support a means for transmitting control signaling indicating a first set of CSI-RS resources including the CSI-RS resources, the first set of CSI-RS resources including periodic resources, where transmitting the CSI reference signals is based on the control signaling. In some examples, the control signaling transmitting manager 1325 may be configured as or otherwise support a means for transmitting, via the control message, an indication of a second set of CSI-RS resources within the observation window, the second set of CSI-RS resources including aperiodic resources, semi-persistent resources, or both, where the time-domain CSI included is based on the first set of CSI-RS resources and the second set of CSI-RS resources.

In some examples, the first set of CSI-RS resources and the second set of CSI-RS resources are associated with a same downlink spatial filter. In some examples, the control message includes a PDCCH message.

Additionally, or alternatively, the communications manager 1320 may support wireless communication at a network entity in accordance with examples as disclosed herein. In some examples, the control signaling transmitting manager 1325 may be configured as or otherwise support a means for transmitting, to a UE, control signaling indicating a CSI reporting configuration for time-domain CSI reporting. In some examples, the CSI-RS transmitting manager 1330 may be configured as or otherwise support a means for transmitting a set of multiple CSI reference signals in accordance with the CSI reporting configuration. In some examples, the control signaling transmitting manager 1325 may be configured as or otherwise support a means for transmitting a control message triggering the UE to provide a time-domain A-CSI report for indicating time-domain CSI. In some examples, the CSI report receiving manager 1335 may be configured as or otherwise support a means for receiving the time-domain A-CSI report based on the control message, the time-domain A-CSI report indicating a quantity of measurements performed on the set of multiple CSI reference signals, where the quantity of measurements is based on a computational consumption associated with the UE.

In some examples, the capability signaling receiving manager 1340 may be configured as or otherwise support a means for receiving, from the UE, capability signaling associated with the computational consumption at the UE, where transmitting the control signaling, transmitting the set of multiple CSI reference signals, or both, is based on the capability signaling. In some examples, the computational consumption is associated with a quantity of occupied central processing units at the UE, a quantity of active CSI reference signal ports at the UE, or both.

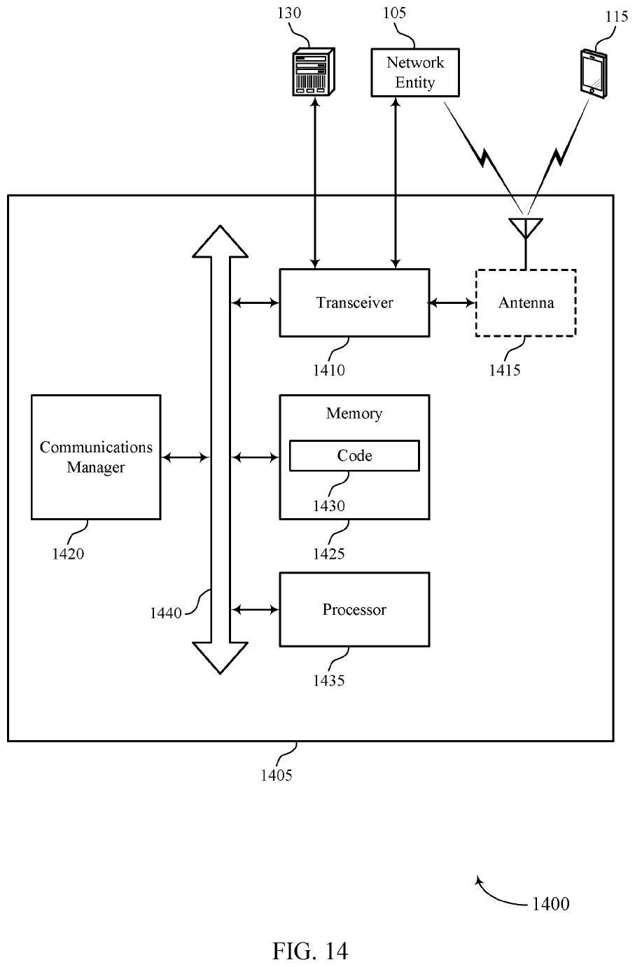

FIG. 14 shows a diagram of a system 1400 including a device 1405 that supports buffer restriction for time-domain CSI reporting in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting buffer restriction for time-domain CSI reporting). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting, to a UE, a control message triggering the UE to provide a time-domain A-CSI report for indicating time-domain CSI associated with CSI-RS resources within an observation window, where a beginning of the observation window is based on when the control message is received. The communications manager 1420 may be configured as or otherwise support a means for transmitting CSI reference signals via the CSI-RS resources that occur within the observation window. The communications manager 1420 may be configured as or otherwise support a means for receiving, from the UE and based on transmitting the CSI reference signals, the time-domain A-CSI report indicating measured time-domain CSI associated with the observation window, where the measured time-domain CSI is based on the CSI reference signals.

Additionally, or alternatively, the communications manager 1420 may support wireless communication at a network entity in accordance with examples as disclosed herein. For example, the communications manager 1420 may be configured as or otherwise support a means for transmitting, to a UE, control signaling indicating a CSI reporting configuration for time-domain CSI reporting. The communications manager 1420 may be configured as or otherwise support a means for transmitting a set of multiple CSI reference signals in accordance with the CSI reporting configuration. The communications manager 1420 may be configured as or otherwise support a means for transmitting a control message triggering the UE to provide a time-domain A-CSI report for indicating time-domain CSI. The communications manager 1420 may be configured as or otherwise support a means for receiving the time-domain A-CSI report based on the control message, the time-domain A-CSI report indicating a quantity of measurements performed on the set of multiple CSI reference signals, where the quantity of measurements is based on a computational consumption associated with the UE.

By including or configuring the communications manager 1420 in accordance with examples as described herein, the device 1405 may support techniques for defining observation windows over which time-domain CSI is to be measured and reported via time-domain aperiodic CSI reports. By defining an observation window for time-domain aperiodic CSI reporting, techniques described herein may limit a quantity of CSI measurements and associated information that UEs 115 are expected to buffer or store in memory. As such, techniques described herein may reduce processing resources used to buffer large quantities of CSI measurements and reduce memory requirements at the respective UEs 115. Moreover, by reducing a burden on processing resources, techniques described herein may reduce a power consumption at the UEs 115, and reduce or prevent wasted processing resources in the event the UEs 115 are not triggered to perform an time-domain aperiodic CSI report.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of buffer restriction for time-domain CSI reporting as described herein, or the processor 1435 and the memory 1425 may be otherwise configured to perform or support such operations.

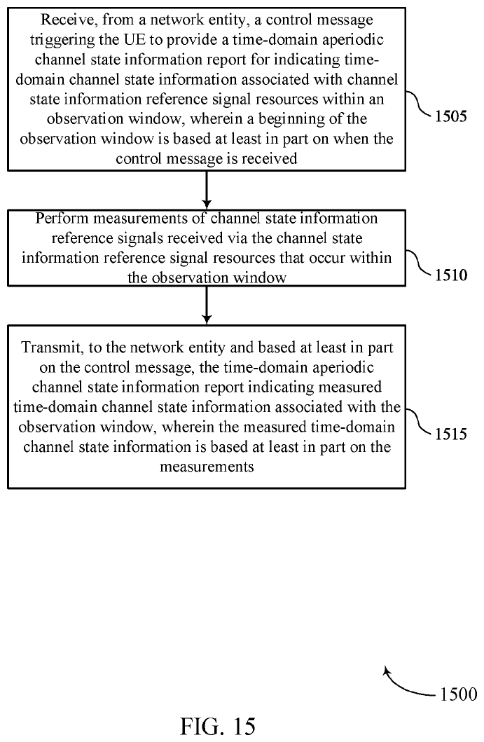

FIG. 15 shows a flowchart illustrating a method 1500 that supports buffer restriction for time-domain CSI reporting in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a control message triggering the UE to provide a time-domain A-CSI report for indicating time-domain CSI associated with CSI-RS resources within an observation window, where a beginning of the observation window is based on when the control message is received. The operations of 1505 may be performed in accordance with examples as disclosed herein. In some examples, aspects of the operations of 1505 may be performed by a control signaling receiving manager 925 as described with reference to FIG. 9.

At 1510, the method may include performing measurements of CSI reference signals received via the CSI-RS resources that occur within the observation window. The operations of 1510 may be performed in accordance with examples as disclosed herein. In some examples, aspects of the operations of 1510 may be performed by a CSI measurement manager 930 as described with reference to FIG. 9.

At 1515, the method may include transmitting, to the network entity and based on the control message, the time-domain A-CSI report indicating measured time-domain CSI associated with the observation window, where the measured time-domain CSI is based on the measurements. The operations of 1515 may be performed in accordance with examples as disclosed herein. In some examples, aspects of the operations of 1515 may be performed by a CSI report transmitting manager 935 as described with reference to FIG. 9.

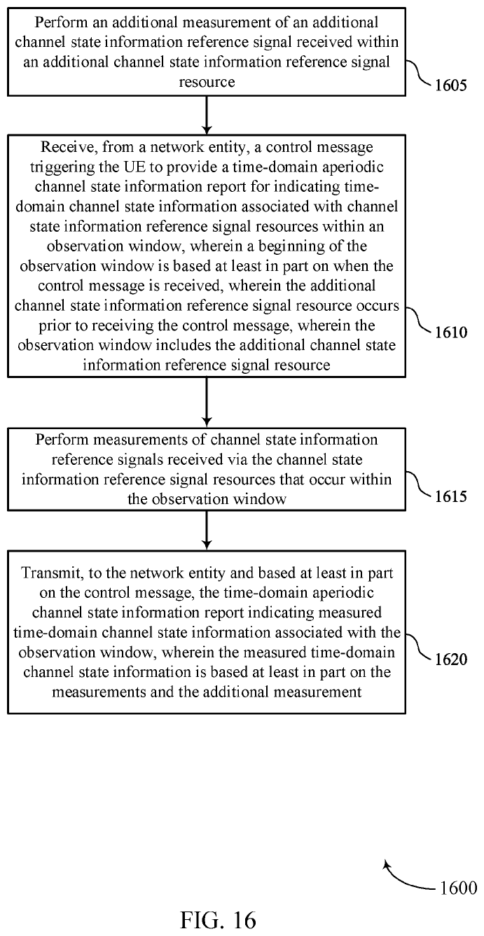

FIG. 16 shows a flowchart illustrating a method 1600 that supports buffer restriction for time-domain CSI reporting in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include performing an additional measurement of an additional CSI reference signal received within an additional CSI-RS resource. The operations of 1605 may be performed in accordance with examples as disclosed herein. In some examples, aspects of the operations of 1605 may be performed by a CSI measurement manager 930 as described with reference to FIG. 9.

At 1610, the method may include receiving, from a network entity, a control message triggering the UE to provide a time-domain A-CSI report for indicating time-domain CSI associated with CSI-RS resources within an observation window, where a beginning of the observation window is based on when the control message is received where the additional CSI-RS resource occurs prior to receiving the control message, and where the observation window includes the additional CSI-RS resource. The operations of 1610 may be performed in accordance with examples as disclosed herein. In some examples, aspects of the operations of 1610 may be performed by a control signaling receiving manager 925 as described with reference to FIG. 9.

At 1615, the method may include performing measurements of CSI reference signals received via the CSI-RS resources that occur within the observation window. The operations of 1615 may be performed in accordance with examples as disclosed herein. In some examples, aspects of the operations of 1615 may be performed by a CSI measurement manager 930 as described with reference to FIG. 9.

At 1620, the method may include transmitting, to the network entity and based on the control message, the time-domain A-CSI report indicating measured time-domain CSI associated with the observation window, where the measured time-domain CSI is based on the measurements and the additional measurement. The operations of 1620 may be performed in accordance with examples as disclosed herein. In some examples, aspects of the operations of 1620 may be performed by a CSI report transmitting manager 935 as described with reference to FIG. 9.

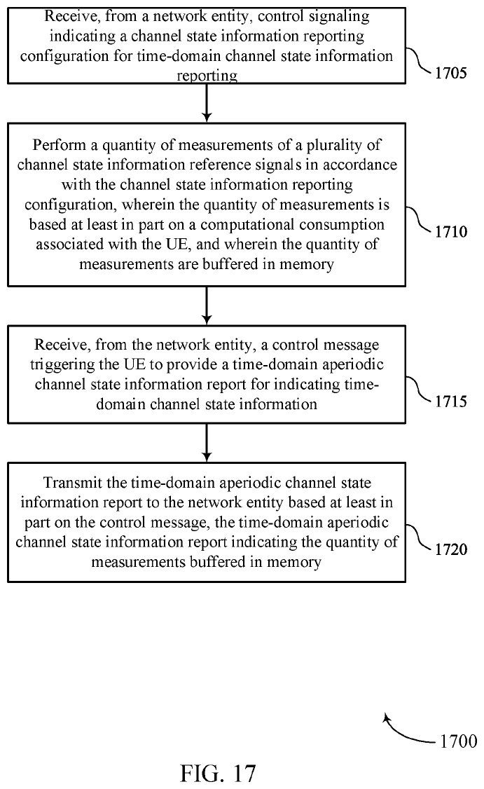

FIG. 17 shows a flowchart illustrating a method 1700 that supports buffer restriction for time-domain CSI reporting in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, control signaling indicating a CSI reporting configuration for time-domain CSI reporting. The operations of 1705 may be performed in accordance with examples as disclosed herein. In some examples, aspects of the operations of 1705 may be performed by a control signaling receiving manager 925 as described with reference to FIG. 9.

At 1710, the method may include performing a quantity of measurements of a set of multiple CSI reference signals in accordance with the CSI reporting configuration, where the quantity of measurements is based on a computational consumption associated with the UE, and where the quantity of measurements are buffered in memory. The operations of 1710 may be performed in accordance with examples as disclosed herein. In some examples, aspects of the operations of 1710 may be performed by a CSI measurement manager 930 as described with reference to FIG. 9.

At 1715, the method may include receiving, from the network entity, a control message triggering the UE to provide a time-domain A-CSI report for indicating time-domain CSI. The operations of 1715 may be performed in accordance with examples as disclosed herein. In some examples, aspects of the operations of 1715 may be performed by a control signaling receiving manager 925 as described with reference to FIG. 9.

At 1720, the method may include transmitting the time-domain A-CSI report to the network entity based on the control message, the time-domain A-CSI report indicating the quantity of measurements buffered in memory. The operations of 1720 may be performed in accordance with examples as disclosed herein. In some examples, aspects of the operations of 1720 may be performed by a CSI report transmitting manager 935 as described with reference to FIG. 9.

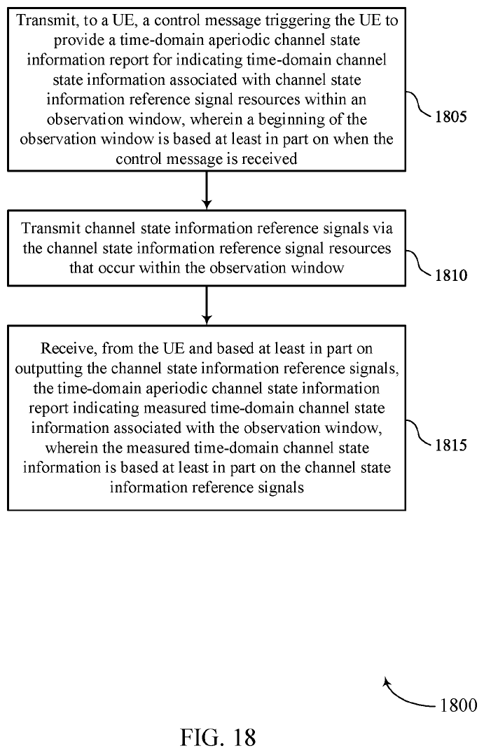

FIG. 18 shows a flowchart illustrating a method 1800 that supports buffer restriction for time-domain CSI reporting in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, a control message triggering the UE to provide a time-domain A-CSI report for indicating time-domain CSI associated with CSI-RS resources within an observation window, where a beginning of the observation window is based on when the control message is received. The operations of 1805 may be performed in accordance with examples as disclosed herein. In some examples, aspects of the operations of 1805 may be performed by a control signaling transmitting manager 1325 as described with reference to FIG. 13.

At 1810, the method may include transmitting CSI reference signals via the CSI-RS resources that occur within the observation window. The operations of 1810 may be performed in accordance with examples as disclosed herein. In some examples, aspects of the operations of 1810 may be performed by a CSI-RS transmitting manager 1330 as described with reference to FIG. 13.

At 1815, the method may include receiving, from the UE and based on transmitting the CSI reference signals, the time-domain A-CSI report indicating measured time-domain CSI associated with the observation window, where the measured time-domain CSI is based on the CSI reference signals. The operations of 1815 may be performed in accordance with examples as disclosed herein. In some examples, aspects of the operations of 1815 may be performed by a CSI report receiving manager 1335 as described with reference to FIG. 13.

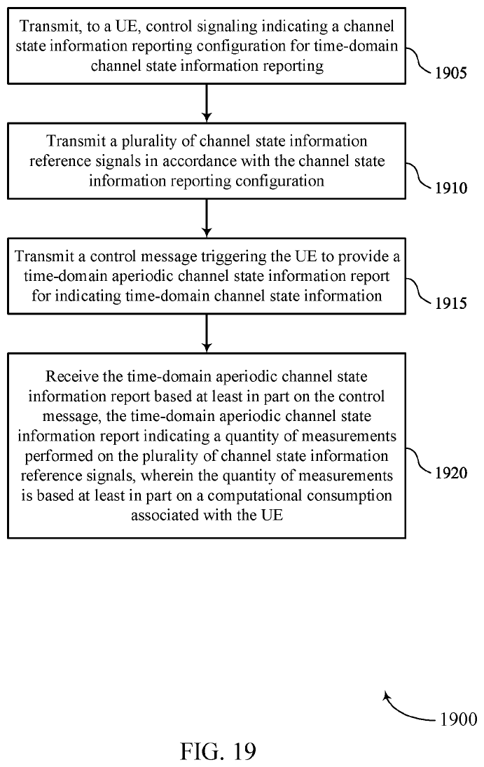

FIG. 19 shows a flowchart illustrating a method 1900 that supports buffer restriction for time-domain CSI reporting in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, control signaling indicating a CSI reporting configuration for time-domain CSI reporting. The operations of 1905 may be performed in accordance with examples as disclosed herein. In some examples, aspects of the operations of 1905 may be performed by a control signaling transmitting manager 1325 as described with reference to FIG. 13.

At 1910, the method may include transmitting a set of multiple CSI reference signals in accordance with the CSI reporting configuration. The operations of 1910 may be performed in accordance with examples as disclosed herein. In some examples, aspects of the operations of 1910 may be performed by a CSI-RS transmitting manager 1330 as described with reference to FIG. 13.

At 1915, the method may include transmitting a control message triggering the UE to provide a time-domain A-CSI report for indicating time-domain CSI. The operations of 1915 may be performed in accordance with examples as disclosed herein. In some examples, aspects of the operations of 1915 may be performed by a control signaling transmitting manager 1325 as described with reference to FIG. 13.

At 1920, the method may include receiving the time-domain A-CSI report based on the control message, the time-domain A-CSI report indicating a quantity of measurements performed on the set of multiple CSI reference signals, where the quantity of measurements is based on a computational consumption associated with the UE. The operations of 1920 may be performed in accordance with examples as disclosed herein. In some examples, aspects of the operations of 1920 may be performed by a CSI report receiving manager 1335 as described with reference to FIG. 13.

The following provides an overview of aspects of the present disclosure:

Aspect 1: A method for wireless communication at a UE, comprising: receiving, from a network entity, a control message triggering the UE to provide a time-domain aperiodic CSI report for indicating time-domain CSI associated with CSI-RS resources within an observation window, wherein a beginning of the observation window is based at least in part on when the control message is received; performing measurements of CSI-RSs received via the CSI-RS resources that occur within the observation window; and transmitting, to the network entity and based at least in part on the control message, the time-domain aperiodic CSI report indicating measured time-domain CSI associated with the observation window, wherein the measured time-domain CSI is based at least in part on the measurements.

Aspect 2: The method of aspect 1, further comprising: performing an additional measurement of an additional CSI-RS received within an additional CSI-RS resource that occurs prior to receiving the control message, wherein the observation window includes the additional CSI-RS resource; and transmitting the time-domain aperiodic CSI report comprising the measured time-domain CSI that is based at least in part on the additional measurement.

Aspect 3: The method of aspect 2, further comprising: receiving control signaling indicating a plurality of periodic CSI-RS resources including the CSI-RS resources and the additional CSI-RS resource, wherein receiving the control message, performing the measurements on the CSI-RSs received via the CSI-RS resources, performing the additional measurement, or any combination thereof, is based at least in part on the control signaling.

Aspect 4: The method of aspect 3, wherein the plurality of periodic CSI-RS resources is associated with a periodicity, and an offset between the additional CSI-RS resource and the control message is less than the periodicity.

Aspect 5: The method of any of aspects 2 through 4, further comprising: storing or buffering the additional measurement in memory in accordance with a CSI reporting configuration, wherein the UE stores or buffers in memory a most recent CSI-RS measurement based at least in part on the CSI reporting configuration, wherein the additional measurement is the most recent CSI-RS measurement that is stored or buffered in memory.

Aspect 6: The method of any of aspects 1 through 5, further comprising: operating in accordance with an inactive duration of a discontinuous reception configuration during a last CSI-RS resource that is prior to the control message in a time domain, wherein the observation window begins after receiving the control message based at least in part on operating in accordance with the inactive duration of the discontinuous reception configuration.

Aspect 7: The method of aspect 6, wherein an inactivity timer associated with the discontinuous reception configuration is greater than or equal to the observation window in a time domain.

Aspect 8: The method of any of aspects 1 through 7, wherein the CSI-RS resources within the observation window comprise aperiodic CSI-RS resources, semi-persistent CSI-RS resources, or both, and the observation window begins after receiving the control message.

Aspect 9: The method of any of aspects 1 through 8, further comprising: receiving, via the control message, an indication of the CSI-RS resources within the observation window and an indication of a downlink spatial filter associated with each of the CSI-RS resources, the CSI-RS resources comprising one or more aperiodic CSI-RS resources, wherein performing the measurements on the CSI-RSs is based at least in part on receiving the indication of the downlink spatial filter.

Aspect 10: The method of any of aspects 1 through 9, wherein the CSI-RS resources are associated with a semi-persistent CSI-RS resource set, the method further comprising: receiving, via the control message, an indication of a time duration associated with the CSI-RS resource set, wherein the measurements are performed on the CSI-RSs within the time duration and within the observation window.

Aspect 11: The method of any of aspects 1 through 10, further comprising: receiving control signaling indicating a first set of CSI-RS resources including the CSI-RS resources, the first set of CSI-RS resources comprising periodic resources, wherein performing the measurements of the CSI-RSs is based at least in part on receiving the control signaling; receiving, via the control message, an indication of a second set of CSI-RS resources within the observation window, the second set of CSI-RS resources comprising aperiodic resources, semi-persistent resources, or both; and performing additional measurements of the second set of CSI-RS resources within the observation window based at least in part on the control message, wherein the time-domain CSI is based at least in part on the measurements and the additional measurements.

Aspect 12: The method of aspect 11, wherein the first set of CSI-RS resources and the second set of CSI-RS resources are associated with a same downlink spatial filter.

Aspect 13: The method of any of aspects 1 through 12, wherein the control message comprises a physical downlink control channel message.

Aspect 14: A method for wireless communication at a UE, comprising: receiving, from a network entity, control signaling indicating a CSI reporting configuration for time-domain CSI reporting; performing a quantity of measurements of a plurality of CSI-RSs in accordance with the CSI reporting configuration, wherein the quantity of measurements is based at least in part on a computational consumption associated with the UE, and wherein the quantity of measurements are buffered in memory; receiving, from the network entity, a control message triggering the UE to provide a time-domain aperiodic CSI report for indicating time-domain CSI; and transmitting the time-domain aperiodic CSI report to the network entity based at least in part on the control message, the time-domain aperiodic CSI report indicating the quantity of measurements buffered in memory.

Aspect 15: The method of aspect 14, further comprising: transmitting, to the network entity, capability signaling associated with the computational consumption at the UE, wherein receiving the control signaling, performing the quantity of measurements, or both, is based at least in part on the capability signaling.

Aspect 16: The method of any of aspects 14 through 15, wherein the computational consumption is associated with a quantity of occupied central processing units at the UE, a quantity of active CSI-RS ports at the UE, or both.

Aspect 17: A method for wireless communication at a network entity, comprising: transmitting, to a UE, a control message triggering the UE to provide a time-domain aperiodic CSI report for indicating time-domain CSI associated with CSI-RS resources within an observation window, wherein a beginning of the observation window is based at least in part on when the control message is received; transmitting CSI-RSs via the CSI-RS resources that occur within the observation window; and receiving, from the UE and based at least in part on transmitting the CSI-RSs, the time-domain aperiodic CSI report indicating measured time-domain CSI associated with the observation window, wherein the measured time-domain CSI is based at least in part on the CSI-RSs.

Aspect 18: The method of aspect 17, further comprising: transmitting an additional CSI-RS via an additional CSI-RS resource that occurs prior to transmitting the control message, wherein the observation window includes the additional CSI-RS resource; and receiving the time-domain aperiodic CSI report comprising the measured time-domain CSI that is based at least in part on the additional CSI-RS.

Aspect 19: The method of aspect 18, further comprising: transmitting control signaling indicating a plurality of periodic CSI-RS resources including the CSI-RS resources and the additional CSI-RS resource, wherein transmitting the control message, transmitting the CSI-RSs via the CSI-RS resources, transmitting the additional CSI-RS, or any combination thereof, is based at least in part on the control signaling.

Aspect 20: The method of aspect 19, wherein the plurality of periodic CSI-RS resources is associated with a periodicity, and an offset between the additional CSI-RS resource and the control message is less than the periodicity.

Aspect 21: The method of any of aspects 17 through 20, wherein the observation window begins after receiving the control message based at least in part on a discontinuous reception configuration at the UE.

Aspect 22: The method of aspect 21, wherein an inactivity timer associated with the discontinuous reception configuration is greater than or equal to the observation window in a time domain.

Aspect 23: The method of any of aspects 17 through 22, wherein the CSI-RS resources within the observation window comprise aperiodic CSI-RS resources, semi-persistent CSI-RS resources, or both, and the observation window begins after transmitting the control message.

Aspect 24: The method of any of aspects 17 through 23, further comprising: transmitting, via the control message, an indication of the CSI-RS resources within the observation window and an indication of a downlink spatial filter associated with each of the CSI-RS resources, the CSI-RS resources comprising one or more aperiodic CSI-RS resources, wherein transmitting the CSI-RSs is based at least in part on the downlink spatial filter.

Aspect 25: The method of any of aspects 17 through 24, wherein the CSI-RS resources are associated with a semi-persistent CSI-RS resource set, the method further comprising: transmitting, via the control message, an indication of a time duration associated with the semi-persistent CSI-RS resource set, wherein the CSI-RSs are transmitted within the time duration and within the observation window.

Aspect 26: The method of any of aspects 17 through 25, further comprising: transmitting control signaling indicating a first set of CSI-RS resources including the CSI-RS resources, the first set of CSI-RS resources comprising periodic resources, wherein transmitting the CSI-RSs is based at least in part on the control signaling; and transmitting, via the control message, an indication of a second set of CSI-RS resources within the observation window, the second set of CSI-RS resources comprising aperiodic resources, semi-persistent resources, or both, wherein the time-domain CSI included is based at least in part on the first set of CSI-RS resources and the second set of CSI-RS resources.

Aspect 27: The method of aspect 26, wherein the first set of CSI-RS resources and the second set of CSI-RS resources are associated with a same downlink spatial filter.

Aspect 28: The method of any of aspects 17 through 27, wherein the control message comprises a physical downlink control channel message.

Aspect 29: A method for wireless communication at a network entity, comprising: transmitting, to a UE, control signaling indicating a CSI reporting configuration for time-domain CSI reporting; transmitting a plurality of CSI-RSs in accordance with the CSI reporting configuration; transmitting a control message triggering the UE to provide a time-domain aperiodic CSI report for indicating time-domain CSI; and receiving the time-domain aperiodic CSI report based at least in part on the control message, the time-domain aperiodic CSI report indicating a quantity of measurements performed on the plurality of CSI-RSs, wherein the quantity of measurements is based at least in part on a computational consumption associated with the UE.

Aspect 30: The method of aspect 29, further comprising: receiving, from the UE, capability signaling associated with the computational consumption at the UE, wherein transmitting the control signaling, transmitting the plurality of CSI-RSs, or both, is based at least in part on the capability signaling.

Aspect 31: The method of any of aspects 29 through 30, wherein the computational consumption is associated with a quantity of occupied central processing units at the UE, a quantity of active CSI-RS ports at the UE, or both.

Aspect 32: An apparatus for wireless communication at a UE, comprising a processor; memory coupled with the processor; and instructions stored in the memory and executable by the processor to cause the apparatus to perform a method of any of aspects 1 through 13.

Aspect 33: An apparatus for wireless communication at a UE, comprising at least one means for performing a method of any of aspects 1 through 13.

Aspect 34: A non-transitory computer-readable medium storing code for wireless communication at a UE, the code comprising instructions executable by a processor to perform a method of any of aspects 1 through 13.

Aspect 35: An apparatus for wireless communication at a UE, comprising a processor; memory coupled with the processor; and instructions stored in the memory and executable by the processor to cause the apparatus to perform a method of any of aspects 14 through 16.

Aspect 36: An apparatus for wireless communication at a UE, comprising at least one means for performing a method of any of aspects 14 through 16.

Aspect 37: A non-transitory computer-readable medium storing code for wireless communication at a UE, the code comprising instructions executable by a processor to perform a method of any of aspects 14 through 16.

Aspect 38: An apparatus for wireless communication at a network entity, comprising a processor; memory coupled with the processor; and instructions stored in the memory and executable by the processor to cause the apparatus to perform a method of any of aspects 17 through 28.

Aspect 39: An apparatus for wireless communication at a network entity, comprising at least one means for performing a method of any of aspects 17 through 28.

Aspect 40: A non-transitory computer-readable medium storing code for wireless communication at a network entity, the code comprising instructions executable by a processor to perform a method of any of aspects 17 through 28.

Aspect 41: An apparatus for wireless communication at a network entity, comprising a processor; memory coupled with the processor; and instructions stored in the memory and executable by the processor to cause the apparatus to perform a method of any of aspects 29 through 31.

Aspect 42: An apparatus for wireless communication at a network entity, comprising at least one means for performing a method of any of aspects 29 through 31.

Aspect 43: A non-transitory computer-readable medium storing code for wireless communication at a network entity, the code comprising instructions executable by a processor to perform a method of any of aspects 29 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive, from a network entity, a control message triggering the UE to provide a time-domain aperiodic channel state information report for indicating time-domain channel state information associated with channel state information reference signal resources within an observation window, wherein a beginning of the observation window is based at least in part on when the control message is received;
perform measurements of channel state information reference signals received via the channel state information reference signal resources that occur within the observation window; and
transmit, to the network entity and based at least in part on the control message, the time-domain aperiodic channel state information report indicating measured time-domain channel state information associated with the observation window, wherein the measured time-domain channel state information is based at least in part on the measurements.

2. The apparatus of claim 1, wherein the instructions are further executable by the processor to cause the apparatus to:
perform an additional measurement of an additional channel state information reference signal received within an additional channel state information reference signal resource that occurs prior to receiving the control message, wherein the observation window includes the additional channel state information reference signal resource; and
transmit the time-domain aperiodic channel state information report comprising the measured time-domain channel state information that is based at least in part on the additional measurement.

3. The apparatus of claim 2, wherein the instructions are further executable by the processor to cause the apparatus to:
receive control signaling indicating a plurality of periodic channel state information reference signal resources including the channel state information reference signal resources and the additional channel state information reference signal resource, wherein receiving the control message, performing the measurements on the channel state information reference signals received via the channel state information reference signal resources, performing the additional measurement, or any combination thereof, is based at least in part on the control signaling.

4. The apparatus of claim 3, wherein the plurality of periodic channel state information reference signal resources is associated with a periodicity, and wherein an offset between the additional channel state information reference signal resource and the control message is less than the periodicity.

5. The apparatus of claim 2, wherein the instructions are further executable by the processor to cause the apparatus to:
store or buffer the additional measurement in memory in accordance with a channel state information reporting configuration, wherein the UE stores or buffers in memory a most recent channel state information reference signal measurement based at least in part on the channel state information reporting configuration, wherein the additional measurement is the most recent channel state information reference signal measurement that is stored or buffered in memory.

6. The apparatus of claim 1, wherein the instructions are further executable by the processor to cause the apparatus to:
operate in accordance with an inactive duration of a discontinuous reception configuration during a last channel state information reference signal resource that is prior to the control message in a time domain, wherein the observation window begins after receiving the control message based at least in part on operating in accordance with the inactive duration of the discontinuous reception configuration.

7. The apparatus of claim 6, wherein an inactivity timer associated with the discontinuous reception configuration is greater than or equal to the observation window in a time domain.

8. The apparatus of claim 1, wherein the channel state information reference signal resources within the observation window comprise aperiodic channel state information reference signal resources, semi-persistent channel state information reference signal resources, or both, and wherein the observation window begins after receiving the control message.

9. The apparatus of claim 1, wherein the instructions are further executable by the processor to cause the apparatus to:
receive, via the control message, an indication of the channel state information reference signal resources within the observation window and an indication of a downlink spatial filter associated with each of the channel state information reference signal resources, the channel state information reference signal resources comprising one or more aperiodic channel state information reference signal resources, wherein performing the measurements on the channel state information reference signals is based at least in part on receiving the indication of the downlink spatial filter.

10. The apparatus of claim 1, wherein the channel state information reference signal resources are associated with a semi-persistent channel state information reference signal resource set, and the instructions are further executable by the processor to cause the apparatus to:
receive, via the control message, an indication of a time duration associated with the semi-persistent channel state information reference signal resource set, wherein the measurements are performed on the channel state information reference signals within the time duration and within the observation window.

11. The apparatus of claim 1, wherein the instructions are further executable by the processor to cause the apparatus to:
receive control signaling indicating a first set of channel state information reference signal resources including the channel state information reference signal resources, the first set of channel state information reference signal resources comprising periodic resources, wherein performing the measurements of the channel state information reference signals is based at least in part on receiving the control signaling;
receive, via the control message, an indication of a second set of channel state information reference signal resources within the observation window, the second set of channel state information reference signal resources comprising aperiodic resources, semi-persistent resources, or both; and
perform additional measurements of the second set of channel state information reference signal resources within the observation window based at least in part on the control message, wherein the time-domain channel state information is based at least in part on the measurements and the additional measurements.

12. The apparatus of claim 11, wherein the first set of channel state information reference signal resources and the second set of channel state information reference signal resources are associated with a same downlink spatial filter.

13. The apparatus of claim 1, wherein the control message comprises a physical downlink control channel message.

14. An apparatus for wireless communication at a network entity, comprising:
a processor;
memory coupled with the processor; and
instructions stored in the memory and executable by the processor to cause the apparatus to:
transmit, to a user equipment (UE), a control message triggering the UE to provide a time-domain aperiodic channel state information report for indicating time-domain channel state information associated with channel state information reference signal resources within an observation window, wherein a beginning of the observation window is based at least in part on when the control message is received;
transmit channel state information reference signals via the channel state information reference signal resources that occur within the observation window; and
receive, from the UE and based at least in part on transmitting the channel state information reference signals, the time-domain aperiodic channel state information report indicating measured time-domain channel state information associated with the observation window, wherein the measured time-domain channel state information is based at least in part on the channel state information reference signals.

15. The apparatus of claim 14, wherein the instructions are further executable by the processor to cause the apparatus to:
transmit an additional channel state information reference signal via an additional channel state information reference signal resource that occurs prior to transmitting the control message, wherein the observation window includes the additional channel state information reference signal resource; and
receive the time-domain aperiodic channel state information report comprising the measured time-domain channel state information that is based at least in part on the additional channel state information reference signal.

16. The apparatus of claim 15, wherein the instructions are further executable by the processor to cause the apparatus to:
transmit control signaling indicating a plurality of periodic channel state information reference signal resources including the channel state information reference signal resources and the additional channel state information reference signal resource, wherein transmitting the control message, transmitting the channel state information reference signals via the channel state information reference signal resources, transmitting the additional channel state information reference signal, or any combination thereof, is based at least in part on the control signaling.

17. The apparatus of claim 16, wherein the plurality of periodic channel state information reference signal resources is associated with a periodicity, and wherein an offset between the additional channel state information reference signal resource and the control message is less than the periodicity.

18. The apparatus of claim 14, wherein the observation window begins after receiving the control message based at least in part on a discontinuous reception cycle at the UE.

19. The apparatus of claim 18, wherein an inactivity timer associated with the discontinuous reception cycle is greater than or equal to the observation window in a time domain.

20. The apparatus of claim 14, wherein the channel state information reference signal resources within the observation window comprise aperiodic channel state information reference signal resources, semi-persistent channel state information reference signal resources, or both, and wherein the observation window begins after transmitting the control message.

21. The apparatus of claim 14, wherein the instructions are further executable by the processor to cause the apparatus to:
transmit, via the control message, an indication of the channel state information reference signal resources within the observation window and an indication of a downlink spatial filter associated with each of the channel state information reference signal resources, the channel state information reference signal resources comprising one or more aperiodic channel state information reference signal resources, wherein transmitting the channel state information reference signals is based at least in part on the downlink spatial filter.

22. The apparatus of claim 14, wherein the channel state information reference signal resources are associated with a semi-persistent channel state information reference signal resource set, and the instructions are further executable by the processor to cause the apparatus to:
transmit, via the control message, an indication of a time duration associated with the semi-persistent channel state information reference signal resource set, wherein the channel state information reference signals are transmitted within the time duration and within the observation window.

23. The apparatus of claim 14, wherein the instructions are further executable by the processor to cause the apparatus to:
transmit control signaling indicating a first set of channel state information reference signal resources including the channel state information reference signal resources, the first set of channel state information reference signal resources comprising periodic resources, wherein transmitting the channel state information reference signals is based at least in part on the control signaling; and
transmit, via the control message, an indication of a second set of channel state information reference signal resources within the observation window, the second set of channel state information reference signal resources comprising aperiodic resources, semi-persistent resources, or both, wherein the time-domain channel state information included is based at least in part on the first set of channel state information reference signal resources and the second set of channel state information reference signal resources.

24. The apparatus of claim 23, wherein the first set of channel state information reference signal resources and the second set of channel state information reference signal resources are associated with a same downlink spatial filter.

25. The apparatus of claim 14, wherein the control message comprises a physical downlink control channel message.

26. A method for wireless communication at a user equipment (UE), comprising:
receiving, from a network entity, a control message triggering the UE to provide a time-domain aperiodic channel state information report for indicating time-domain channel state information associated with channel state information reference signal resources within an observation window, wherein a beginning of the observation window is based at least in part on when the control message is received;
performing measurements of channel state information reference signals received via the channel state information reference signal resources that occur within the observation window; and
transmitting, to the network entity and based at least in part on the control message, the time-domain aperiodic channel state information report indicating measured time-domain channel state information associated with the observation window, wherein the measured time-domain channel state information is based at least in part on the measurements.

27. The method of claim 26, further comprising:
performing an additional measurement of an additional channel state information reference signal received within an additional channel state information reference signal resource that occurs prior to receiving the control message, wherein the observation window includes the additional channel state information reference signal resource; and
transmitting the time-domain aperiodic channel state information report comprising the measured time-domain channel state information that is based at least in part on the additional measurement.

28. The method of claim 27, further comprising:
receiving control signaling indicating a plurality of periodic channel state information reference signal resources including the channel state information reference signal resources and the additional channel state information reference signal resource, wherein receiving the control message, performing the measurements on the channel state information reference signals received via the channel state information reference signal resources, performing the additional measurement, or any combination thereof, is based at least in part on the control signaling.

29. A method for wireless communication at a network entity, comprising:
transmitting, to a user equipment (UE), a control message triggering the UE to provide a time-domain aperiodic channel state information report for indicating time-domain channel state information associated with channel state information reference signal resources within an observation window, wherein a beginning of the observation window is based at least in part on when the control message is received;
transmitting channel state information reference signals via the channel state information reference signal resources that occur within the observation window; and
receiving, from the UE and based at least in part on transmitting the channel state information reference signals, the time-domain aperiodic channel state information report indicating measured time-domain channel state information associated with the observation window, wherein the measured time-domain channel state information is based at least in part on the channel state information reference signals.

30. The method of claim 29, further comprising:
transmitting an additional channel state information reference signal via an additional channel state information reference signal resource that occurs prior to transmitting the control message, wherein the observation window includes the additional channel state information reference signal resource; and
receiving the time-domain aperiodic channel state information report comprising the measured time-domain channel state information that is based at least in part on the additional channel state information reference signal.
